(19) United States
(12) Patent Application Publication
(10) Pub. No.: US 2011/0038470 A1
(43) Pub. Date: Feb. 17, 2011

(54) Centrally Located Server Delivery Of Personalized Content To Telecommunications Devices

(76) Inventor: Carl Ernest Kent, Palo Alto, CA (US)

Correspondence Address: MERCHANT & GOULD PC, P.O. BOX 2903, MINNEAPOLIS, MN, 55402-0903, US

(21) Appl. No.: 12/760,202

(22) Filed: Apr. 14, 2010

Related U.S. Application Data
(60) Provisional application No. 61/169,146, filed on Apr. 14, 2009.

(51) Int. Cl. H04M 15/06; H04M 1/56

(52) U.S. Cl. 379/142.04; 379/142.01

(57) ABSTRACT

Methods and systems for personalized content delivery to telecommunications devices are disclosed. One system includes a signal intercept application configured to receive a signal relating to an incoming phone call to a telecommunications device. The system further includes a content server configured to receive a message from the signal intercept application on a data network, the message including identification information relating to the incoming phone call, the content server further configured to select content based on the identification information and transmit that information to the telecommunications device.

### CROSS-REFERENCE TO RELATED APPLICATIONS

The present application claims priority to U.S. Provisional Patent Application No. 61/169,146, filed Apr. 14, 2009, the disclosure of which is hereby incorporated by reference in its entirety.

### TECHNICAL FIELD

The present disclosure relates generally to content gathering and delivery systems related to telecommunications devices. Specifically, the present disclosure relates to methods and systems for personalized content delivery to telecommunications devices.

### BACKGROUND

Caller identification systems are known, in which information about a caller is transmitted in addition to a voice signal. In many systems, the information about the caller is received at the call recipient's phone substantially before (˜up to 2-3 seconds) the phone ring signal is actually activated by the phone, allowing the call recipient to hear the signal.

Some existing telephones, such as cellular phones, can associate caller identification information with one or more known callers, such as callers in an address book stored on the phone. These phones can be programmed by a user to associate specific ringtones or other media playback with callers, such that a party receiving a call will see or hear playback of certain media content upon receiving a phone call.

While many of the systems identify the telephone number and name of the calling party, with such information being displayed either on auxiliary customer premise equipment (CPE) or directly on a display window built into the receiving telephone, some of these systems attempt to delivery video images to either auxiliary customer premise equipment (CPE) or directly on a display window built into the receiving telephone. Because all such prior art systems that deliver video signals in conjunction with caller ID information rely on telecommunications carriers to generate and distribute video signals, these prior systems have significant undesirable user drawbacks. First, the amount of content which can be associated with callers is limited, because of the inherent memory storage limitations of cell phones and other similar devices. Second, the content is static, in that it depends on the cell phone user to update the content stored on the phone. Further, in systems allowing for updated information, both the calling party and the receiving party are required to subscribe to a service, thereby mandating a large number of prerequisite steps before content sharing and content association can occur.

For these and other reasons, improvements are desirable.

### SUMMARY

In accordance with the present disclosure, the above and other problems are solved by the following:

In a first aspect, a system for personalized content delivery to telecommunications devices is disclosed. The system includes a signal intercept application configured to receive a signal relating to an incoming phone call to a telecommunications device. The system further includes a content server configured to receive a message from the signal intercept application on a data network, the message including identification information relating to the incoming phone call, the content server further configured to select content based on the identification information and transmit that information to the telecommunications device.

In a second aspect, a method for providing personalized content delivery to a user of a telecommunications device is disclosed. The method includes linking content with a contact of a user of a telecommunications device. The method also includes receiving caller identification information at a telecommunications device, the caller identification information associated with the contact. The method further includes transmitting a request for content to a content server, and receiving content from the content server associated with the contact. The method additionally includes presenting the content to the user to indicate identity of the contact.

In a third aspect, a method for providing personalized content delivery to a user of a telecommunications device is disclosed. The method includes obtaining content relating to a contact from one or more personal content display sources, and linking the content to the contact. The method further includes receiving caller identification information associated with the contact from a client, selecting one or more pieces of the content, and transmitting the one or more pieces of the content to the client.

In a fourth aspect, a personalized content delivery system is disclosed. The system includes a signal intercept application. The signal intercept application is configured to receive a signal relating to an incoming phone call to a telecommunications device. The signal intercept application is further configured to transmit caller identification information to a content server, receive content from the content server related to a contact identified by the caller identification information, and provide the content for display on a client device.

In a fifth aspect, a personalized content delivery system is disclosed. The system includes a signal intercept application. The signal intercept application is configured to transmit information to a content server relating to an outgoing phone call to a contact. The signal intercept application is further configured to receive an established voice communication link over a data network, and to receive content from the content server related to the contact. The signal intercept application is further configured to provide the content for display on a client device.

In a sixth aspect, a further personalized content delivery system is disclosed. The system includes providing data and services as apart of a rapid time response event. More particularly, the present disclosure, in various specific embodiments, involves methods, systems, apparatus, and/or data formats directed to providing reliable and extensible rapid response data services using an open source architecture.

The present disclosure in various aspects may be embodied as a method or a system or an apparatus for providing an improved telecommunications call center, extended telecommunications carrier central office capability, or similar fast response data services. The disclosure provides an open data protocol method for making data from a variety of sources available during a rapid response. In a further aspect, the disclosure provides a method for collecting data from a variety of sources into a log for rapid response, to assist in supply, and transporting data during time sensitive call setup and terminating sessions at a telecommunications carrier's central office.

All publications, patents, and patent applications cited herein are hereby incorporated by reference in their entirety for all purposes.

### BRIEF DESCRIPTION OF THE DRAWINGS

FIG. 1 illustrates an example network within which aspects of the present disclosure can be implemented;

FIG. 2 is a flowchart of methods and systems for personalized content delivery to telecommunications devices, according to a possible embodiment of the present disclosure;

FIG. 3 is a schematic diagram of a computing system that can be used to implement aspects of the present disclosure;

FIG. 4 is a schematic diagram of a system in which personalized content can be delivered to a telecommunications device in the context of a telephone call, in accordance with a possible embodiment of the present disclosure;

FIG. 5 is a timing diagram for data and voice signals received for a typical incoming phone call;

FIG. 6 is a schematic diagram of data sharing operations performed according to certain aspects of the present disclosure;

FIG. 7 illustrates an example network incorporating a voice communication network useable to implement aspects of the present disclosure;

FIG. 8 illustrates an example network incorporating an IP-based communication network useable to implement aspects of the present disclosure;

FIG. 9 is a block schematic diagram of systems for personalized content delivery, according to a possible embodiment of the present disclosure;

FIG. 10 is a block schematic diagram of a portion of a data network useable to provide personalized content to a telecommunications device, according to an embodiment of the present disclosure;

FIG. 11 illustrates a user interface that can be used to manage content on a content management server, according to various embodiments of the present disclosure;

FIG. 12 illustrates a user interface that can be used to manage contacts loaded onto a content management server, according to various embodiments of the present disclosure;

FIG. 13 illustrates certain content processing modules used to implement aspects of the present disclosure;

FIG. 14 illustrates certain software modules resident on a telecommunications device implementing aspects of the present disclosure;

FIG. 15 is a schematic view of a telecommunications device receiving personalized content delivery in conjunction with an incoming telephone call, according to an example embodiment of the present disclosure;

FIG. 16 illustrates a portion of a network used for providing or receiving personalized content, according to an embodiment of the present disclosure;

FIG. 17 is a flowchart of systems and methods for associating content with a user, according to an embodiment of the present disclosure;

FIG. 18 is a flowchart of systems and methods for personalized content delivery to a telecommunications device, according to a further embodiment of the present disclosure;

FIG. 19 is a flowchart of systems and methods for association of content with contacts, according to an embodiment of the present disclosure;

FIG. 20 illustrates a logical process flow of a phone call initiated over a voice network and implementing aspects of the present disclosure;

FIG. 21 illustrates a logical process flow of a phone call initiated over a data network and implementing aspects of the present disclosure;

FIG. 22 illustrates a further logical process flow of a phone call initiated over a data network and implementing aspects of the present disclosure;

FIG. 23 is a flow chart showing a general method according to the disclosure;

FIG. 24 is a flow chart showing a general method according to the disclosure;

FIG. 25 is a block diagram showing an example system architecture data flow according to specific embodiments of the disclosure;

FIG. 26 is a block diagram showing an example system architecture data flow according to further specific embodiments of the disclosure;

FIG. 27 illustrates an extensible and open source data architecture according to specific embodiments of the disclosure; and

FIG. 28 is a block diagram showing a representative example logic device in which the present disclosure may be embodied.

### DETAILED DESCRIPTION

Various embodiments of the present disclosure will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

The logical operations of the various embodiments are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits.

In general, the present disclosure relates to methods and systems for personalized content delivery to telecommunications devices. Specifically, the present disclosure contemplates allowance of automatic updating of caller-associated content on a telecommunications device, such that a user receiving a call can view content selected by the caller without the caller being required to pre-subscribe to a service. By content, it is intended to include, but is not limited to, user generated content or works of art created by artists with or without said artists having commercial interest or proprietary interest in content such as video, photographic, computer generated graphics, pixel images of any kind, text, and audio content. For example, digital content standards utilized by the present disclosure include, but are not limited to, GIF, flash, HTML, JPEG, MPEG, and the like.

Increasingly, technologies relating to voice and data communications have been in the process of converging, with the advent of smartphones, computing systems, set-top boxes, and other devices capable of connecting to both voice and data networks. The methods and systems of the present disclosure exploit data networks and optionally voice networks as well to dynamically update content displayed to a user, based on that user's contacts and those contacts' presence on the internet. Details regarding the specifics of the personalized content delivery are discussed below.

The present disclosure relates to the field of providing data and services as apart of a rapid time response event originating in a centrally located server, including servers located in a telecommunications carrier central office. More particularly, the present disclosure, in various specific embodiments, involves methods, systems, apparatus, and/or data formats directed to providing reliable and extensible rapid response data services.

The present disclosure presents methods to achieve delivery of low latency, resiliency, fault tolerant, hyper-scalable data and metadata processing during the commission of a rapid response event. In comparison to this system, example systems, such as those described in U.S. Pat. Nos. 534,757; 5,349,638; 5,546,448; 6,061,434; 6,141,058; 6,243,448; 6,427,003; 6,456,852; 6,546,092; 6,650,902; 6,731,727; and 6,990,181 exist. The disclosures of these patents is hereby incorporated by reference in their entireties. Additionally, the disclosure of U.S. patent application Ser. No. 11/962,246, filed Dec. 21, 2007, and entitled “Methods and Systems for Personalized Content Delivery to Telecommunications Devices” is hereby incorporated by reference in its entirety.

While many different functions, features and techniques have been proposed associated with providing fast response data service, these features by and large have been directed to a single definitive source data system that must be continually updated with current data relevant to a fast response service. What these systems have failed to address, for the most part, is the fact that there is a tradeoff to be made between a tightly controlled, highly verified central data system and having access during a rapid response event to the most relevant and most up-to-date data which may be in fact resident in a number of data sources.

For example, phone call receivers generally will want fast access to current information regarding the caller. The most definitive and up to date version of that information is likely to be that resident in a central data source that continuously collects data from one or more databases, including, but not limited to, multiple social network sites such as Facebook, MySpace, Tagged, etc. . . . bearing information on prospective callers. Unless networked for frequent and or continuous updating to a central repository as specified in the present disclosure, data at a decentralized data source, is isolated from the call path of a rapid response, time sensitive call setup and terminating session at a telecommunications carrier's central office.

As a further example, in some instances, data relevant to a phone call receiver, during a rapid response, time sensitive call setup and terminating session at a telecommunications carrier's central office may be of such quality or quantity that it is practical and desirable to collect and store it at a central location. Facebook, MySpace, etc. for example, may have data pertaining to the caller in the form of pictures, video and or audio clips. These social network data sources have standardized application programmer interfaces (APIs) with uniform data formatting standards that make it practical and desirable for users to share their content with third party central databases such as that configured in the present disclosure, thereby making possible the accommodation of sharing this type of content during the a rapid response, time sensitive call setup and terminating session at a telecommunications carrier's central office.

In many respects, where the prior arts individually and collectively fail to deliver desired levels of quality, speed and security with regard to retrieval, display, organization, access, sharing, and repurposing of data during the commission of a rapid response event. For example, on the subject of latency, it is highly desirable in a rapid response event to reduce the amount of elapsed time between the execution of a command and the resulting retrieval of data from RAM memory. In another example, in the area of central server resilience, it is desirable that, in an environment of high call processing volume such as that in a carrier central office or a telecommunications call center, measures should be taken to insure against the possibility of system crashes. In yet another example, on the subject of server capacity expansion, it is desirable to provision a central computer server to handle rapidly expanding call and data transaction volumes.

The present disclosure, including specific embodiments, will be better understood with reference to the following drawings and detailed descriptions. In some of the drawings and detailed descriptions below, the present disclosure is described in terms of the important independent embodiment of a rapid response call setup and call termination system. This should not be taken to limit the invention, which, using the teachings provided herein, can be applied to other situations. For purposes of clarity, this discussion refers to devices, methods, and concepts in terms of specific examples. However, the disclosure and aspects thereof may have applications to a variety of types of devices and systems. It is therefore intended that the disclosure not be limited except as provided in the attached claims.

Furthermore, it is well known in the art that logic or digital systems and methods can include a wide variety of different components and different functions in a modular fashion. Different embodiments of the disclosure can include different mixtures of elements and functions and may group various functions as parts of various elements. For purposes of clarity, the disclosure is described in terms of systems that include many different innovative components and innovative combinations of innovative components and known components. No inference should be taken to limit the disclosure to combinations containing all of the innovative components listed in any illustrative embodiment in this specification.

The functional aspects of the disclosure, as will be understood from the teachings herein, may be implemented or accomplished using any appropriate implementation environment or programming language, such as C++, Cobol, Pascal, Java, Java-script, HTML, dHTML, XML, PHP, Ruby on Rails, or other languages.

### A. Generalized System Architecture Useable for Personalized Content Delivery

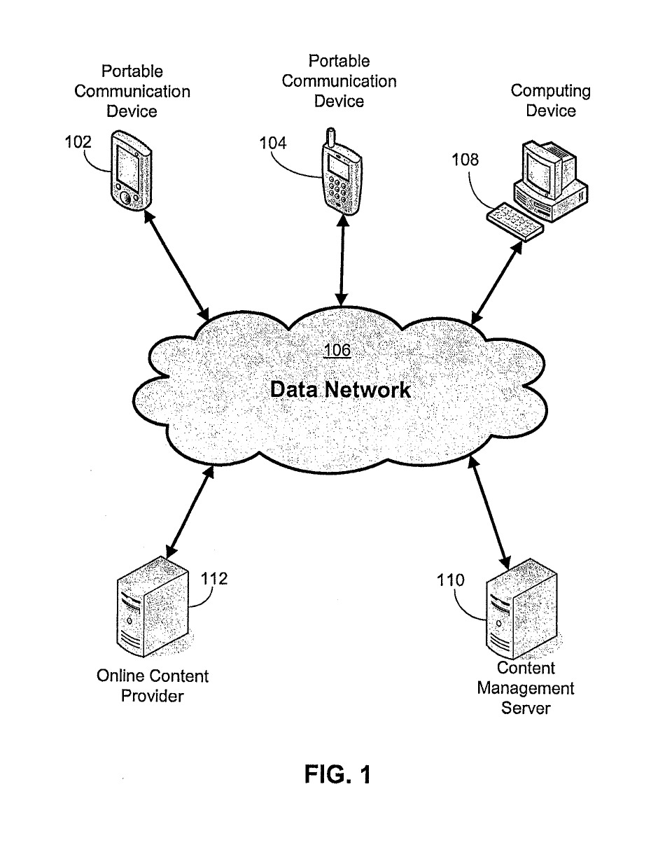

Referring now to FIG. 1, an example network 100 is shown, within which aspects of the present disclosure can be implemented. The network 100 includes a number of telecommunications devices, shown as devices 102, 104. The telecommunication devices 102, 104 can be any of a number of types of devices capable of connecting to a data network 106, such as the internet. For example, the telecommunication devices 102, 104 can be any of a number of types of smartphones, portable computing devices with telecommunications capabilities, or handheld devices. Also note that telecommunications devices (also described herein as communications devices, generally) are defined to include, but are not limited to, personal digital assistants (PDA), computers with or without equipment such as voice over internet protocol (VOIP) telephony software or a plurality of computer operating system software including, but not limited to, Windows, Mac OSX, Palm OS, Symbian OS, and Linux to generate and receive phone calls, cellular telephones, pocket personal computers (pocket PCs), MP3 players, cable television telephonic receivers, and digital land line based terrestrial telephones. In the embodiment shown, device 102 will relate to a user placing a call to a user of device 104.

The data network 106 is a packet-based data network capable of sending and receiving digital data, such as the internet or some portion thereof. The data network 106 can operate on any of a number of protocols, such as SS7-, GSM-, H323-, HTTP-, GSM-data, IP-RAN-, UMTS-, WAP-, Teldesic, Inmarsat-, Iridium-, GPRS-, CDMA-data-, WCDMA-data-, HTTP-, H323-, SMS, MMS-, USSD-, email-LAN-, TCP/IP-, UDP-, POTS-, NDC-, PDC-, imode-, Globalstar- and/or WLAN-, or file formats, such as MP3, WAV, RealSystem Secure or the like to download, transmit and save content. The data network 106 maintains connections to the telecommunications devices 102, 104, to the extent available, during phone calls over other networks, such as networks relating to voice communications.

A computing device 108, content management server 110, and an online content provider 112 are each connected to the data network via standard network connection. The computing device 108 is a general purpose personal computing device, such as a devices useable by a user of one of the telecommunications devices 102, 104, and which can access various content providers 112. The content providers 112 can include any of a variety of social networking sites, professional networking sites, or other user-content collection sites, such as the networking websites maintained by Facebook, Linkedin, Orkut, Picasa, Flickr, or other sites.

The content management server 110 can access data stored on the content providers 112 to obtain content placed there by users. In the embodiment shown, the user of device 104 is generally a subscriber on the content management server 110; the user of the device 102 need not be a subscriber to the server 110 for the systems and methods of the present disclosure to operate. The content management server 110 collects data from the various content providers 112, storing that content as related to the individuals who are associated with that content. The content management server 110 can, in certain embodiments, associate the content and the individuals with user accounts set up in the server. In these embodiments, the content management server 110 can receive a list of contacts from a user of a telecommunications device, such as a user of the device 104. The list of contacts includes the name, phone number, and optionally, the email address, home address, and other personal information relating to a number of users. The content management server 110 can periodically scan third party websites, downloading the content associated with the contacts of the users of the content management server, for access by the wireless telecommunications device 104 upon receipt of a phone call from that corresponding user.

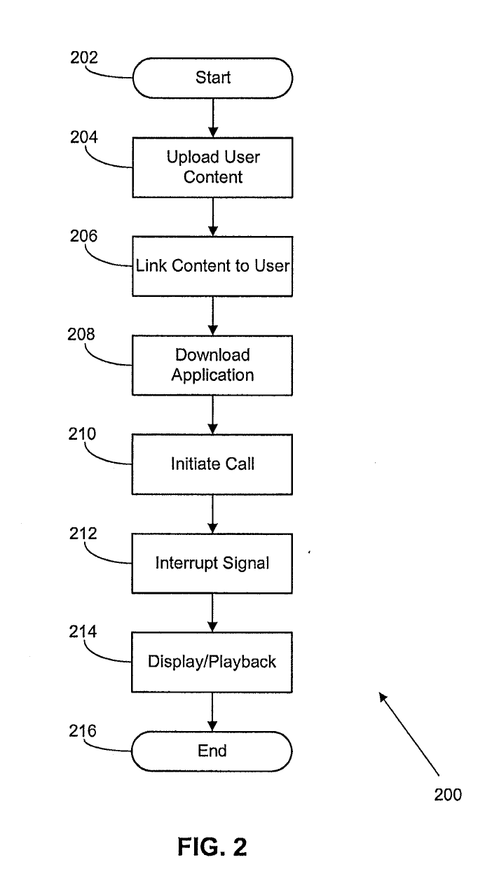

FIG. 2 is a flowchart of methods and systems 200 for personalized content delivery to telecommunications devices, according to a possible embodiment of the present disclosure. The system 200 corresponds to a generalized overall operation system for providing personalized content delivery, allowing a user's contacts to update their profile information in third party applications by uploading content to those applications. The system 200 obtains and uses the content uploaded to the third party applications to identify the contact to the user upon initiation of a voice communications session (i.e. a telephone call over a voice or data network).

Operational flow within the system 200 is instantiated at a start operation 202, which corresponds to initial registration with a content provider, such as the manager of the content management server of FIG. 1. Operational flow proceeds to an upload module 204. The upload module 204 corresponds to a person uploading content to a third party application or website, such as any of the social networking or content storage websites mentioned above. The person uploading the content is generally a contact of the person who is registered as a subscriber to a content delivery service, in accordance with the present disclosure.

In certain embodiments, the upload module 204 also includes the subscribing user uploading a list of contacts to a server, such as a subscribing user of a wireless device uploading a list of contacts to a content management server. The contacts can then be saved by the content management server, for use within the system 200 to associate content therewith.

The upload module 204 further corresponds to a content management server, such as the server 110 of FIG. 1, uploading content relating to the contacts in the subscribing user's contact list. The upload module 204 employs one or more scripts to obtain information from the subscribing user's contact list by correlating that list with users of one or more content-storage websites, such as social networking sites, photograph or other media storage sites, or personal webpages. In some embodiments, the upload module 204 traces from the subscribing user's content to the content of that person's contacts by tracing through to the user's “friends” or “contacts” webpages linked within the same networking sites.

Operational flow proceeds to a link module 206. The link module 206 obtains a contact list from the subscribing user, and links the uploaded content to the associated contact. Any of a number of linking processes can occur, but generally a first linking pass is automatically performed by the system 200 by matching contact information (name, telephone number, etc.) to the name associated with webpages linked to the subscribing user's webpage. The link module 206 can also provide a user interface accessible to the subscribing user, when at a networked computing system, to confirm or amend the links created by the system 200.

Operational flow proceeds to a download module 208, which corresponds to downloading a signal intercept application to a telecommunications device. The download module 208 can send the signal intercept application to the wireless device directly through use of a wireless file transfer protocol, using any of a number of types of file transfer methods, such as various torrent-based software or direct FTP software. The download module 208 can also be implemented through use of a computing system communicatively interconnected to the telecommunications device, such as through use of a USB cable and appropriate software, such as Microsoft's ActiveSync software.

Operational flow proceeds to a call initiation module 210. The call initiation module 210 corresponds to the subscribing user receiving a call signal from another party who is either a subscribing user or not a subscribing user. The phone call is generally configured to carry a data signal, including common carrier furnished central office equipment originated caller ID information, an electronic ring signal, and an analog voice signal. In execution, per Bellcore publications TR-TSY-000030 and TR-TSY-000031, which identify standards applicable to caller ID as commonly implemented in Signal System 7 (SS7) switching equipment found in the vast majority of United States telephone company central offices, originated phone calls generate the delivery of data content to the called parties telecommunications device approximately 4 seconds prior to the delivery of a data signal, alongside an electronic ring signal and an analog voice signal.

Operational flow proceeds to an interrupt module 212. The interrupt module 212 corresponds to execution of a portion of the signal intercept application. The interrupt module 212 interrupts receipt of the phone call, and initiates a request for content to a content management server, such as the server 110 of FIG. 1. The intercept module 212 captures the caller identification information received during the call initiation module 210, and transmits that information to the content management server as a request for content related to the person from whom a call is pending. The intercept module 212 receives the content from the content management server, based on the server's selection of content.

During the approximately 4 second timing differential described in conjunction with the call initiation module 210, telecommunications devices outfitted with a signal intercept (SI) application of the present disclosure receive the caller ID signal into the SI, which in turn reads the phone number of the calling party and, with the user's telecommunication device having its internet browser in continuous operative standby mode, automatically initiates an outbound internet protocol (IP) data call to a server, such as a web server or content management server. The server accesses a record associated with the user, in this case a subscriber, and accesses that user's profile. The server pulls previously associated and stored information, from either the internet server storage or from a real time query of internet based databases on other websites. After the internet server pulls the content, and places said content in cache memory, said internet server pushes content and caller ID information for display on the internet browser of user's telecommunications device.

It also during the aforementioned 4 second silent interval that the SI application, using either triangulation under the network approach of approximating location from identification of the nearest three switches to the subscriber or by means of the global positioning satellite (GPS) method (through functionality resident on a telecommunication device operating portions of the system 200), that the SI collects and transfers location based information to the internet server to approximate the location of the subscriber's geographic whereabouts, useful for selecting and delivering location based digital content. By virtue of embedding the signal intercept (SI) software, which includes either or both a network approach and GPS location identification feature, on subscriber telecommunications devices, the signal intercept application has the ability, before the subscribing user answers or generates a voice call, to affix the subscriber's location, which is relayed via an automated outbound Internet Protocol (IP) data call to obtain signal signature confirmation and relay both the signal signature confirmation and location to a remotely located computer server that selects and transfers in real time, to the subscriber's telecommunications device, location specific digital content (including, but not limited to, rapid notifications and advertisements).

Operational flow proceeds to a display module 214, which presents the content to the user to indicate the existence of an incoming telephone call. The display module 214 can optionally be executed in conjunction with a typical telephone ring signal, thereby providing audio and video notification to the subscribing user of the existence of a call and the identity of the caller. The display module 214 continues operation throughout the duration of a telephone call, displaying the selected content. Continuing the example from above, after the 4 second interval concludes, the user hears the ring signal, answers the call, sees and or hears the digital content on his/her telecommunications device, such as through an internet browser.

Operational flow terminates at an end module 216, which corresponds to completion of the phone call and ceasing display of the content associated with the calling party.

Additional modules can be incorporated into the system 200, in various embodiments of the present disclosure. For example, the system can additionally display advertisements at various other intervals, license agreements, or other information to the user of a wireless device. Furthermore, a location module can use triangulation, global positioning systems (GPS) or other locators to combine with voice signals to place the caller or called party at an approximate location for transmitting relevant advertising or for communication of location to the other party to the call. In still other embodiments, the system can be configured to request content from a content server relating to outbound calls, such that the outbound call is related to a contact associated with content by the content server. Other modules may be incorporated as well.

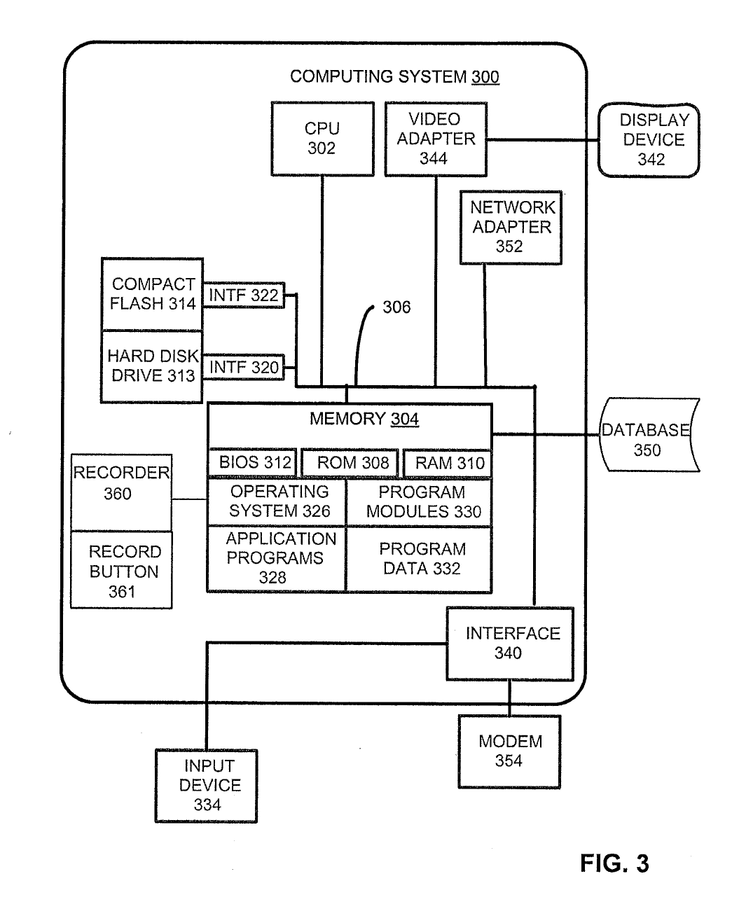

Referring to FIG. 3, an exemplary environment for implementing embodiments of the present disclosure includes a general purpose computing device in the form of a computing system 300, including at least one processing system 302. In the various embodiments described herein, the general purpose computing device can correspond to the various computing devices of FIG. 1, such as the content provider or the content management server (i.e. the content server). A variety of processing units 302 are available from a variety of manufacturers, for example, Intel or Advanced Micro Devices. The computing system 300 also includes a system memory 304, and a system bus 306 that couples various system components including the system memory 304 to the processing unit 302. The system bus 306 might be any of several types of bus structures including a memory bus, or memory controller; a peripheral bus; and a local bus using any of a variety of bus architectures.

Preferably, the system memory 304 includes read only memory (ROM) 308 and random access memory (RAM) 310. A basic input/output system 312 (BIOS), containing the basic routines that help transfer information between elements within the computing system 300, such as during start up, is typically stored in the ROM 308.

Preferably, the computing system 300 further includes a secondary storage device 313, such as a hard disk drive, for reading from and writing to a hard disk (not shown), and/or a compact flash card 314.

The hard disk drive 313 and compact flash card 314 are connected to the system bus 306 by a hard disk drive interface 320 and a compact flash card interface 322, respectively. The drives and cards and their associated computer readable media provide nonvolatile storage of computer readable instructions, data structures, program modules and other data for the computing system 300.

Although the exemplary environment described herein employs a hard disk drive 313 and a compact flash card 314, it should be appreciated by those skilled in the art that other types of computer-readable media, capable of storing data, can be used in the exemplary system. Examples of these other types of computer-readable mediums include magnetic cassettes, flash memory cards, digital video disks, Bernoulli cartridges, CD ROMS, DVD ROMS, random access memories (RAMs), read only memories (ROMs), and the like.

A number of program modules may be stored on the hard disk 313, compact flash card 314, ROM 308, or RAM 310, including an operating system 326, one or more application programs 328, other program modules 330, and program data 332. A user may enter commands and information into the computing system 300 through an input device 334. Examples of input devices might include a keyboard, mouse, microphone, joystick, game pad, satellite dish, scanner, digital camera, touch screen, and a telephone. These and other input devices are often connected to the processing unit 302 through an interface 340 that is coupled to the system bus 306. These input devices also might be connected by any number of interfaces, such as a parallel port, serial port, game port, or a universal serial bus (USB). A display device 342, such as a monitor or touch screen LCD panel, is also connected to the system bus 306 via an interface, such as a video adapter 344. The display device 342 might be internal or external. In addition to the display device 342, computing systems, in general, typically include other peripheral devices (not shown), such as speakers, printers, and palm devices.

When used in a LAN networking environment, the computing system 300 is connected to the local network through a network interface or adapter 352. When used in a WAN networking environment, such as the Internet, the computing system 300 typically includes a modem 354 or other means, such as a direct connection, for establishing communications over the wide area network. The modem 354, which can be internal or external, is connected to the system bus 306 via the interface 340. In a networked environment, program modules depicted relative to the computing system 300, or portions thereof, may be stored in a remote memory storage device. It will be appreciated that the network connections shown are exemplary and other means of establishing a communications link between the computing systems may be used.

The computing system 300 might also include a recorder 360 connected to the memory 304. The recorder 360 includes a microphone for receiving sound input and is in communication with the memory 304 for buffering and storing the sound input. Preferably, the recorder 360 also includes a record button 361 for activating the microphone and communicating the sound input to the memory 304.

A computing device, such as computing system 300, typically includes at least some form of computer-readable media. Computer readable media can be any available media that can be accessed by the computing system 300. By way of example, and not limitation, computer-readable media might comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium that can be used to store the desired information and that can be accessed by the computing system 300.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media. Computer-readable media may also be referred to as computer program product.

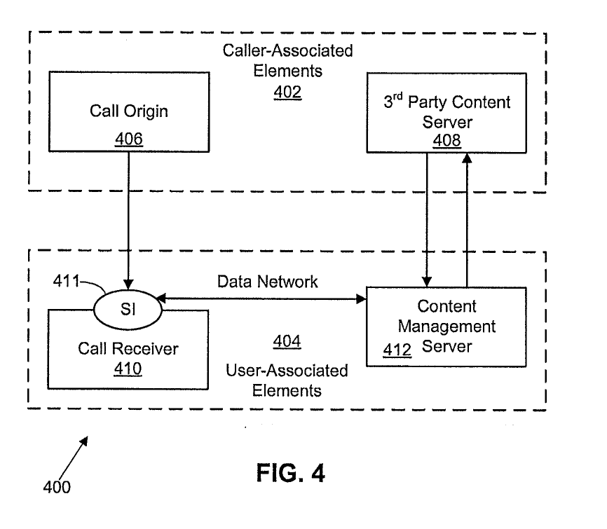

FIG. 4 is a schematic diagram of a system 400 in which personalized content can be delivered to a telecommunications device in the context of a telephone call, in accordance with a possible embodiment of the present disclosure. The system 400 generally includes caller-associated elements 402, and user-associated elements 404. The caller associated elements 402 includes a call origin 406, and a third party content server 408. The user-associated elements 404 include a call receiver 410 with a signal interceptor 411, and a content management server 412. Operation and relationships among these components is discussed below.

The call origin 406 can be any of a number of telecommunications devices, such as a landline or cellular telephone communicating over a public switched telephone network or other voice network. The call origin 406 is preferably associated with a person who is in the contacts list of the person they are calling, and preferably is also associated with that person on one or more social networking sites, such as the third party content server 408, such that the person is easily linked to the call recipient.

The call origin 406 can also be, in other embodiments, a computing system capable of initiating a voice call over a data network, such as a system configured to use a voice-over-internet-protocol (VoIP) system, such as Skype, Vonage, Jajah, Wengo, or other types of providers.

The call receiver 410 can be any of a number of telecommunications devices or devices having telecommunications capabilities, such as a cellular telephone, smartphone, personal digital assistant, computing system, set-top box, media player (e.g. mp3 or DVD player), or other digital device capable of receiving data over a voice network. The call receiver 410 has a signal intercept application 411 associated with it (e.g. installed on the system) that intercepts incoming calls over voice and/or data networks, and communicates with the content management server 412 over a data network to request content relating to the individual associated with the caller identification information received as a part of the incoming call signal. The content management server 412 can access the third party content server 408, or can have cached content related to the contact, and will provide that data to the signal intercept application 411 for display on the call receiver 410.

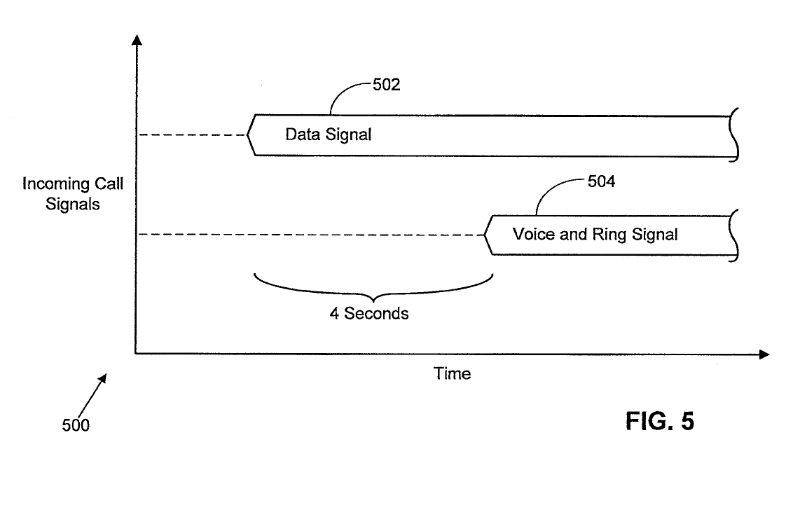

FIG. 5 is a timing diagram 500 for data and voice signals received for a typical incoming phone call. The timing diagram 500 illustrates example signals received in the instance of receipt of an incoming telephone call, such as a phone call received over a voice or data network according to the Bellcore publications TR-TSY-000030 and TR-TSY-000031. The timing diagram 500 illustrates receipt of a data signal 502 and a voice and ring signal 504. As shown, the data signal 502, which includes, among other components, caller identification information, is received by the receiving party's phone approximately four seconds prior to receipt of the voice and ring signal 504. The voice and ring signal 504 carries the analog voice signal and the ring signal indicating to the receiving phone that a call is being received.

The present disclosure refers to a signal intercept application, such as the signal intercept application 411 of FIG. 4, as a software component which determines the presence of an incoming phone call and, based on that determination, can initiate an outbound data request to obtain content from a content management server. This outbound request can, in various embodiments, be triggered upon either of the voice and ring signal 504 or the data signal 502. In these different embodiments of the present disclosure, the signal intercept application may be referred to as a ring signal intercept application or a data signal intercept application, respectively. In either case, the software system actuating the outbound data request is the signal intercept application, which requires caller identification information received on the data signal 502. Because the signal intercept application only requires this information, it does not need to wait for receipt of the voice and ring signal 504 to initiate the data request.

In certain embodiments, the four seconds between receipt of the data signal 502 and the voice and ring signal 504 is sufficient to send a data request and receive content in a response from a content management server, consistent with the principles of the present disclosure (e.g. in the case of a data signal intercept application). In such an instance, the voice and ring signal 504 causes the phone receiving the inbound call to ring once that signal 504 is received. However, in certain occurrences (e.g. when the outbound request is triggered on the voice and ring signal 504 or when the outbound data request based on the data signal 502 has not been fulfilled within 4 seconds), the signal intercept application may, in certain embodiments, suppress the ring signal from triggering the phone to ring until the associated content is received. In alternative embodiments, the signal intercept application will allow the phone to ring, and will alter the phone display/sound according to the received content once a response to the data request is received. Other embodiments are possible as well.

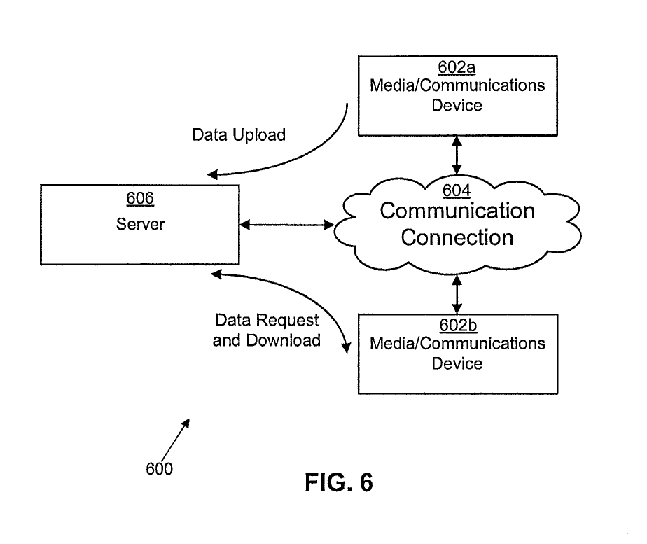

FIG. 6 is a schematic diagram of data sharing operations performed according to certain aspects of the present disclosure. The schematic diagram 600 provides a high level diagram of data movement within the various systems of the present disclosure. The diagram illustrates communications devices 602a-b interconnected by a communication connection 604. A server 606 is also interconnected with the devices 602a-b via the communication connection.

The devices 602a-b are typically mobile devices capable of voice and data communications. For example, the devices can be cellular telephones, smartphones, personal digital assistants, laptops, or other similar devices. The devices can also be, for example, personal computing systems, such as the generalized computing system described above in conjunction with FIG. 3.

The communication connection 604 provides a data connection among the devices 602a-b, and also optionally a voice connection (e.g. through a standard voice network or using VoIP and wireless connection using 802.11g, WiMAX, or other similar communication protocols available for connection of devices). The server 606 can be accessed by the devices 602a-b, and can provide content to one or more of those devices.

In the embodiment of the diagram 600 shown, media device 602a uploads data to the server, while media device 602b performs a data request and downloads data from the server. The data can include, in various embodiments, content, contacts, advertisements, or other information that may be desired by users of the devices 602a-b.

In certain additional embodiments, the device 602b can be said to download data from the device 602a after requesting data from the server 604, such as through downloading of a torrented file segmented for download from one or more networked users.

The server 606 can include one or more servers, and is generally representative of a data storage location communicatively interconnected with various client devices. In the embodiment shown, the server 606 is interconnected to devices 602a-b through the communication connection 604.

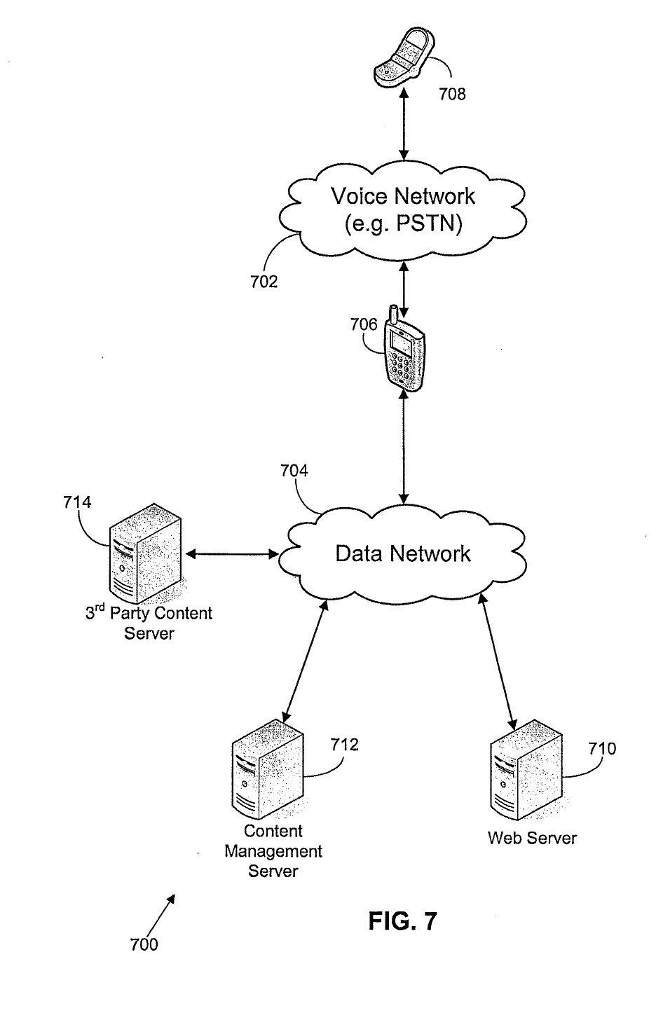

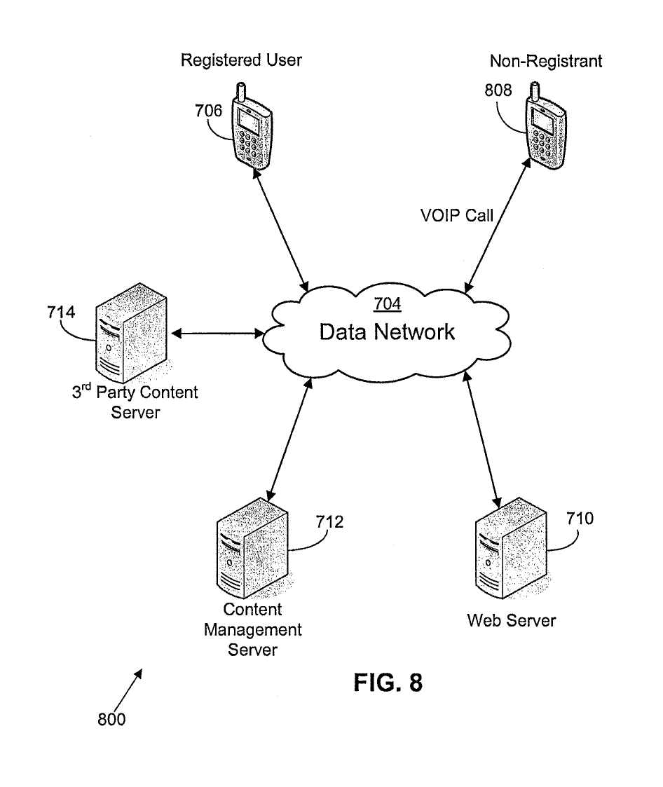

FIGS. 7-8 illustrate example networks useable to implement aspects of the present disclosure. FIG. 7 illustrates a network 700 allowing voice and data communications over two or more types of networks. The network 700 includes a voice network 702 and a data network 704. The voice network 702 is any of a number of types of voice communication networks, such as a PSTN network. The data network 704 can be any of a number of types of data communication networks, such as SS7-, GSM-, H323-, HTTP-, GSM-data, IP-RAN-, UMTS-, WAP-, Teldesic, Inmarsat-, Iridium-, GPRS-, CDMA-data-, WCDMA-data-, HTTP-, H323-, SMS, MMS-, USSD-, email-LAN-, TCP/IP-, UDP-, POTS-, NDC-, PDC-, imode-, Globalstar- and/or WLAN-, or some combination thereof.

A telecommunications device 706 connects to the voice network 702 to receive and transmit phone calls (on the voice or data networks), such as to another telecommunications device 708. The device 706 also connects to the data network 704 to receive and transmit data, such as among a web server 710, a content management server 712, or third party content server 714. The telecommunicates device can be any of the types of communications devices previously described, such as a smartphone, PDA, cellular phone, set-top box, mp3 player, or other computing system.

The present disclosure contemplates, in certain embodiments, use of both networks 702, 704 in conjunction with a device capable of connecting to both networks, to combine voice network content (e.g. caller identification information) with data network information (e.g. content associated with contacts) to provide a uniquely personalized content display system relating to incoming phone calls on a voice network.

Referring now to FIG. 8, a network 800 allowing voice and data communications over a data network is shown. The network 800 generally corresponds to the network 700 of FIG. 7, but does not include the voice network 702. Rather the data network 704 allows connection by one or more devices 806 that allow voice communications over a data network, such as any of a number of VoIP applications previously mentioned.

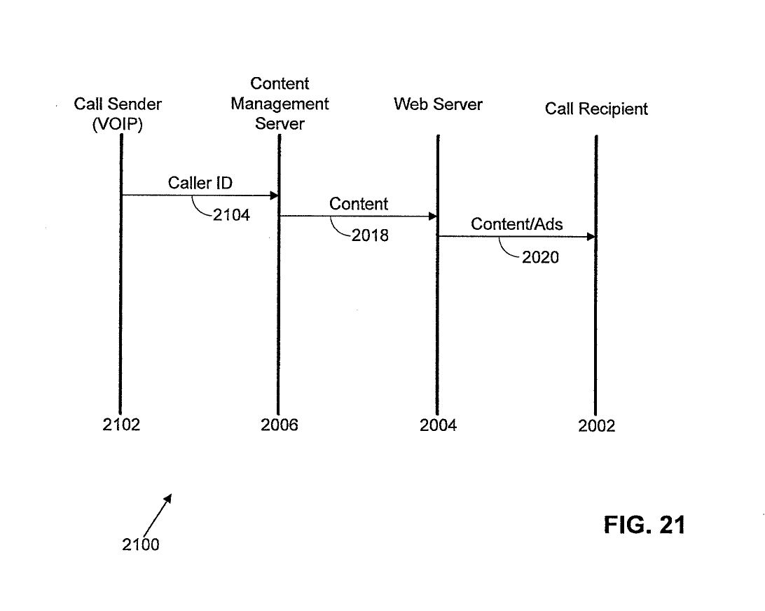

In certain embodiments, the network 800 can be used in conjunction with internet-based widget VoIP calls. In such calls, the telecommunications device can receive a call over the internet which is initiated at a server, which receives connection impetus based on a widget clicked onto by a user of a website. Additional details regarding incorporation of widget-based VoIP calling is described below in conjunction with FIG. 21.

### B. Server and Telecommunications Device Functionalities, Interconnections, and Usages

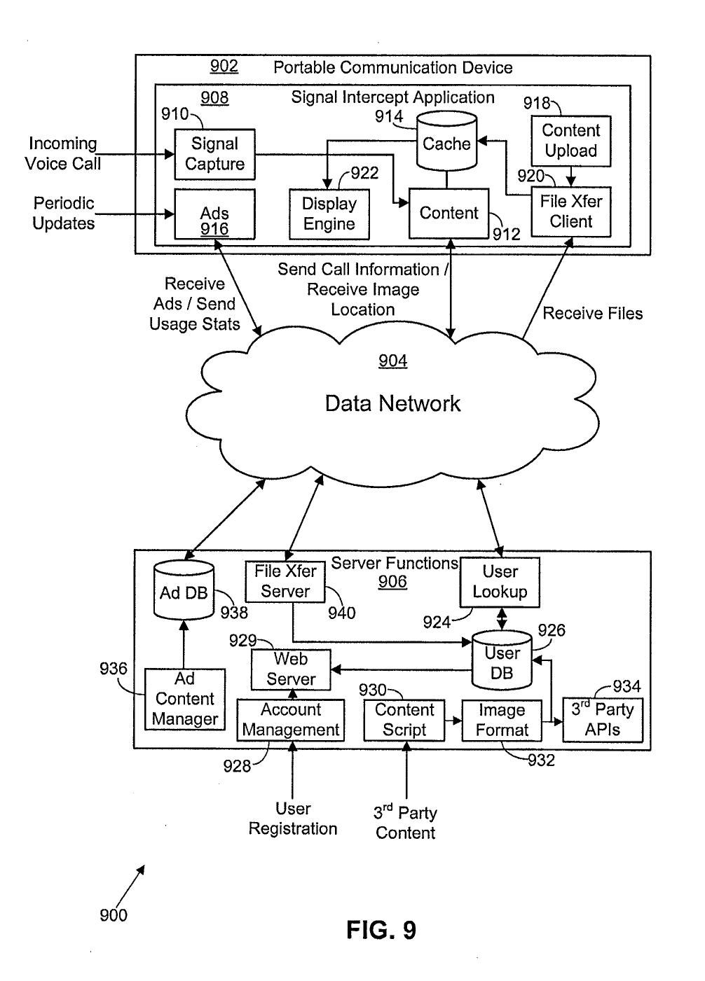

FIGS. 9-16 refer to functionalities, interconnections, data flows, and usages of server and telecommunications devices, according to the various aspects of the present disclosure. These figures describe a number of the possible embodiments of systems with which personalized content delivery can be accomplished.

FIG. 9 is a block schematic diagram of an overall system 900 for personalized content delivery, according to a possible embodiment of the present disclosure. The system 900 can be represented generally in hardware and software, and can be implemented using the various logical and physical components described in elsewhere herein. The system 900 incorporates the various content delivery components of the present disclosure, arranged generally at a portable communication device 902 and a server 904. The device and server are communicatively connected by a network 906, such as a data network described above in conjunction with FIGS. 6-8.

The portable communication device 902 is generally a telecommunications device, as has previously been described, having a signal intercept application 908 installed thereon. The signal intercept application generally obtains and automatically routes incoming caller identification information to a remote computing system, and retrieves, caches, and displays content associated with a contact associated with that caller identification information. In the embodiment shown, the signal intercept application 908 includes a variety of components, including a signal capture component 910, a content component 912, a data cache 914, an advertisements component 916, a content upload component 918, a file transfer client 920, and a display engine 922. Other components may be incorporated into the signal intercept application as well.

The signal capture component 910 receives signals from incoming voice calls, such as calls over a voice network or data network. The signal capture component is linked to the content component 912, which is arranged to send a query on the data network 906 to the server 904. The query sent by the content component 912 generally includes caller identification information, and optionally also includes location information. The location information can be any of a variety of information about the location of the portable communication device, such as information based on GPS or triangulation methods as determined by software and/or hardware components resident on the communication device 902. The content component 912 receives, in response to the query, data associated with the contact of the user who corresponds to the caller identification information, and formats the content in a manner useable on the device 902. For example, the content component 912 can route the query from the signal capture component 910 to the server 904, receive content in return, and format that content to fit the display size and format requirements of the device 902. The content component 912 then stores that information in the data cache 914.

The advertisements component 916 receives periodic advertising updates, such as from the server 904 or from a third party advertising server. In one embodiment, the advertisements component 916 uploads advertisements weekly for random or targeted display to the user of the device 902. Additionally, the advertisements component 916 can send usage statistics on the network 906 to the server 904, allowing the server to send targeted advertising regarding pages/content viewed on the device 902. The advertisements component 916 can also receive updates relating to location information from other portions of the communication device 902 outside the signal intercept application 908 (e.g. from signal triangulation techniques or use of global positioning systems (GPS)) to be sent alongside the usage information to the server 904. In such systems, the advertisements component can receive location-specific advertisements from the server based on the location of the device 902.

In certain embodiments, the advertisements component 916 uses a cookie able to track web activity of the device 902 to better enable advertisements to be targeted to the user of the device 902. The advertisements component 916 periodically transmits this usage information to a server, such as the server 904, for analysis and delivery of advertisements based on that usage.

The content upload component 918 allows a user to upload content from the device to the server 904 for association with that user's subscriber account. The user can also update his/her account information using the content upload component.

The file transfer client 920 allows direct file transfer of a number of files between users, and can be embodied in a compact, high speed file transfer protocol, such as is used in a bit torrent file transfer. Other file transfer protocols, such as standard FTP transfer, can be used by the client 920 as well.

The display engine 922 displays the content when the call is initiated, allowing the user to view the content received from the server 904. In the embodiment shown, the display engine 922 retrieves formatted content from the cache 914 for display on a monitor of the device 902, such as within a web or file browser window.

The server 904 generally provides content linking/association functionality to the overall system 900, by associating content on various third party websites with contacts associated with a subscribing user (e.g. the owner of the portable communication device 902). In the embodiment shown, the server 904 includes a user lookup component 924, a user database 926, a web server component 928, a content script 930, a formatting component 932, an interface component 934, an advertising manager 936, and advertising database 938, and a file transfer server component 940.

The user lookup component 924 receives queries from the content component 912 of the device 902, including caller identification information. The user lookup component accesses the user database 926 to determine (1) whether the user is a subscribing user associated with the server 904, and (2) whether the caller identification information corresponds to content in the user database 926 linked to a contact of the user's. For example, the caller identification information can correspond to a person in an address book of the user's smartphone or other device, which is uploaded and duplicated in the user database 926. The contacts in the address book are linked to content from third party content aggregation sites, such as the social networking sites described above.

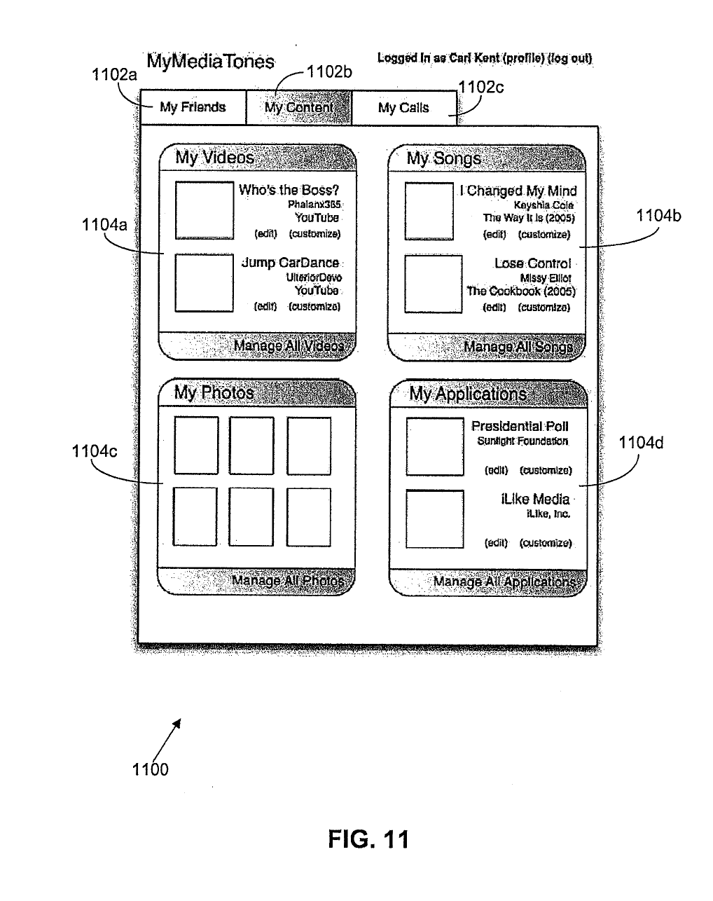

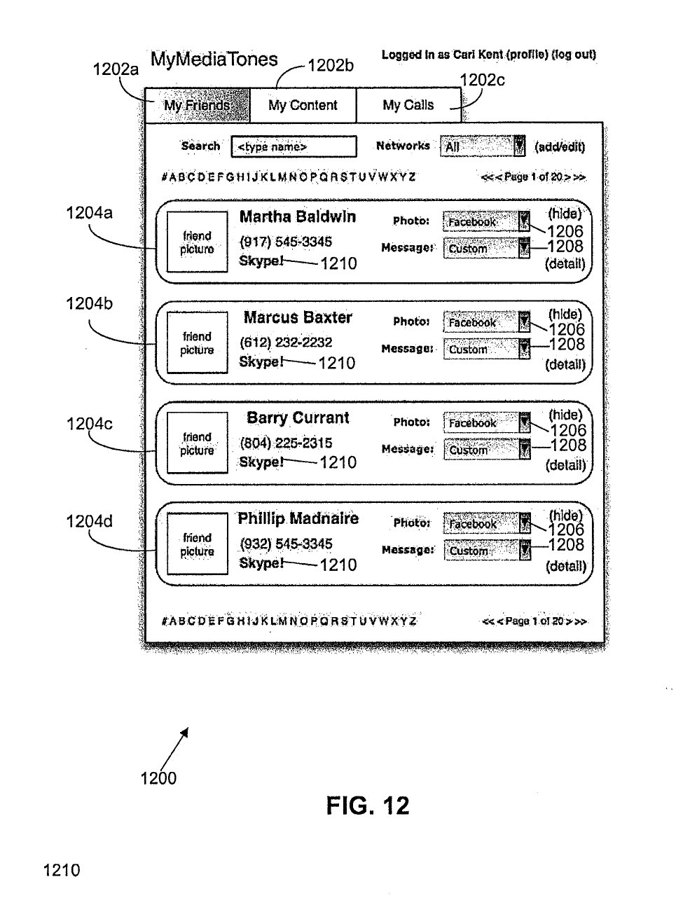

The web server component 928 generates a variety of user interfaces able to be displayed on a computing system communicatively interconnected to the server 904, such as the generalized system described above in FIG. 3. The web server component 928 operates in conjunction with the user database 926 and an account management component 929, which coordinate with the web server component 928 to display account and user information to a user. The web server component allows a user to view user interfaces which provide controls relating to server functions, such as those which allow account access and display options, relating to manually adjusting content associations with contacts, manually setting user account and/or payment options, and selecting third party sources from which to draw content. Other user options and user interfaces may be generated by the web server component 928 as well. Example user interfaces useable for content and contact management are described below in conjunction with FIGS. 11-12.

The content script 930 receives content from third parties' content storage/aggregation sites. The content script 930 is configured to access content on those sites according to information managed by the interface component 934, allowing the content script to parse through the content stored on the site (e.g. Facebook or the other sites described above) for download to the server 904. The formatting component 932 receives the content obtained through operation of the content script 930, and formats the content in a manner able to be managed by the server 904 and stored in the user database

The interface component 934 stores and manages interface standards for connection to one or more types of application programming interfaces used by content management sites, such as social networking sites Facebook, Orkut, and others. The interface component 934 links to the formatting component 932 and the content script 930 to provide the interface standards required to be used by the content script 930 to obtain content for storage in the user database 926. In certain embodiments, the interface component 934 stores and manages interfaces such as those consistent with the Open Social platform interface provided by Google, Inc. of Mountain View, Calif. Other non-standard interfaces may be managed by the interface component 934 as well.

The advertising manager 936 manages storage and distribution of advertisements to the communication devices of subscribing users. The advertising manager is linked to and controls an advertising database 938, which contains a repository of advertisements able to be selectively transmitted to client devices. In certain embodiments, the advertising manager 936 receives data from cookies resident on client devices to determine optimal advertisements for delivery to those users. In further embodiments, the advertising manager sends a large number of advertisements to the client device, which in turn selects targeted advertising for display to the user (e.g. through use of the advertisements component 916).

In certain embodiments, the advertising manager 936 receives information from the advertisements component 916 of the communication device 902 relating to usage activity of the device. This information can include call history, browsing history, or other usage information. In such embodiments, the advertising manager 936 uses web analytics capabilities, such those available through Google Analytics, WebTrends, or other sources, to match advertisements and/or content with the user based on that user's usage history on the communications device 902. The analytics allows administrators of the server 904 to determine efficient advertising delivery methods, and to maximize revenue based on targeted advertising directed to personal communications devices.

In further embodiments, the advertising manager can receive location based information from the advertisements component 916 of the communication device 902 as well. The location based information, which can be determined or generated by GPS or triangulation methods in the communications device 902 (generally outside the scope of the signal intercept application described above, but receivable by that application as input data) can be used to deliver location-specific advertisements to the advertisements component 916 of the device 902 for presentment to the user.

The file transfer server component 940 provides a server portion of a file transfer application, configured to deliver files upon demand to a user machine, such as the portable communication device 902. The file transfer server component 940 and can be implemented in a traditional demand-pull type file server configuration.

The various components of the server 904 may reside on one or more computing systems, communicatively connected to allow data communications among the various components as described above. For example, the server functionality can exist on a number of networked general purpose computing systems, such as the system described in FIG. 3, above. The components may also include additional data sharing capabilities or communicative connections, such as by allowing the advertising database 938 and/or advertising manager 936 access to user settings in the user database. Furthermore, other components or functionality may be included in the system as well.

In certain embodiments, the communications among the devices in the system 900 can be accomplished through use of any of a variety of messaging protocols, such as an XML protocol using SOAP-based messaging between the portable communication device 902 and server 904. In such embodiments, data containers can be used which correspond to the different supported data types in the system, such as integer, string, GUID, Boolean, binary, text, and date/time data types. Other communications protocols and data types may be used as well.

Additionally, the server 904 may include various logging functionality incorporated into the various subcomponents thereof. For example, the server 904 may include a database logging accesses of the server by subscribing users, which would be accessible to the advertising manager 936, user lookup component 924, or other components which would allow accumulation of phone call records for data mining regarding preferences of the subscribing users with respect to advertising or content delivery, or for delivery of other services to that user or to a user base as a whole.

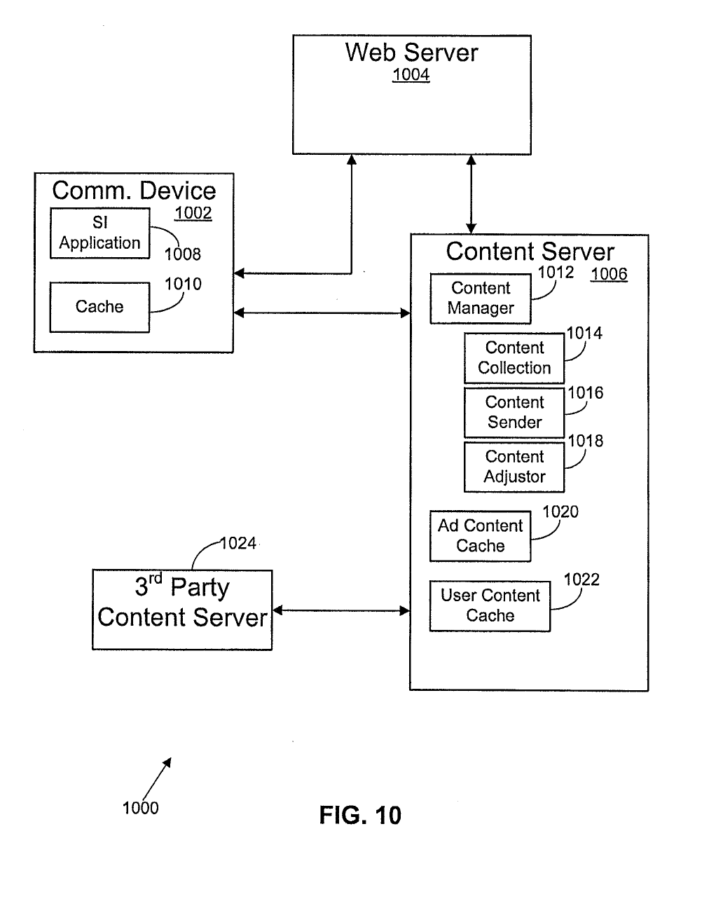

FIG. 10 is a block schematic diagram of a portion of a data network 1000 useable to provide personalized content to a telecommunications device, according to an embodiment of the present disclosure. The data network 1000 generally shows a possible embodiment in which the functionality described above in FIG. 9 can be implemented, and illustrates functional blocks used in that implementation. In the embodiment shown, the data network 1000 includes a communications device 1002 communicatively connected to a web server 1004 and a content server 1006.

The communications device 1002 includes a signal intercept application 1008 and a cache 1010. The signal intercept application 1008 is generally a software application installable onto the communications device 1002 and configured to intercept caller identification information received with incoming voice calls. The cache 1010 can be any of a number of types of memory configured for storage of data, such as a flash memory, random access memory, disk drive storage, or other memory devices/types. In certain embodiments, the cache 1010 is a reserved portion of a memory space available for use as data memory.

The web server 1004 provides a web interface to the communication device 1002 or other computing systems, such as the general purpose computing system described in FIG. 3, above. The web server 1004 allows a user access to various content and settings, including allowing the user to amend associations between content and contacts, as well as to set personal preferences relating to content displayed associated with specific contacts, or personal preferences relating to display/formatting of content and/or advertising when delivered to the user's communications device. The web server 1004 is communicatively connected directly to the content server 1006, and shares data with the content server 1006 to accomplish the various user administration and content management tasks allowed to occur beyond the direct access of content from the content server 1006 by the communications device 1002.

The content server 1006 manages the content and user preferences for each account associated with a user of a telecommunications device 1002. The content server can communicatively connect to any of a variety of telecommunications devices 1002, as well as to the web server 1004. The content server 1006 includes a content manager 1012, which in turn coordinates with a content collector 1014, sender 1016, and adjustor 1018. The content server 1006 further includes an advertisement content cache 1020 and a user content cache 1022.

The content manager 1012 coordinates content collection, adjustment, and sending of content between the content server, the telecommunications device 1002, the web server 1004, and a third party content server 1024, which is described below. The content manager 1012 selectively calls the content collector 1014, the sender 1016, and the adjustor 1018 to accomplish various of these tasks. The content collector 1014 is generally responsible for collecting content from the third party content server 1024, and, in various embodiments, uses or includes the various scripts and interfaces described above in conjunction with FIG. 9 to obtain content. The content sender 1016 sends content to the communications device 1002 requesting content, in response to received incoming caller identification information. The content adjustor 1018 adjusts content received by the content collector 1014, and formats that content for storage in the content server 1006 and optionally also in a format for display on specific, targeted communications devices having varied formats of displays or differing display software.

The advertisement content cache 1020 stores advertisements for delivery to one or more communications devices 1002 for display alongside content, such as in a hyperlinked text string placed along a bottom edge of the content display window on the communications devices. The advertisement content cache 1020 can store advertisements provided to it by third parties, and can be configured to output (e.g. with the assistance of advertising management software) advertisements targeted to specific users based on any of a number of factors, including, for example, the user's web usage history, content display history, advertising settings for contacts having accounts managed by the content server 1006, or other options. The advertisements content cache 1020 can store specific analytic trends determined using the content server 1006, such that relevant advertisements can be provided to the communications device 1002 alongside content.

The user content cache 1022 manages storage of user content gathered from one or more third party content servers. In various embodiments, the user content cache 1022 can correspond to the user database 926 of FIG. 9.

The third party content server 1024 can communicatively connect to the content server 1006, and provides content to the content server which in turn associates that content with contacts of a subscribing user. The third party content server 1024 is generally an account-based, content aggregating server allowing the subscribing user to have an account which can link to other individuals' accounts, such as exists for various social networking website architectures (e.g. Facebook, LinkedIn, Orkut, and others).

Other embodiments of the network 1000 can exist as well to incorporate the various functionality described above in FIG. 9. For example, additional servers can exist beyond the web server and the content server. Additional third party content servers can be incorporated into the network 1000 as well.

FIG. 11 illustrates a user interface 1100 that can be used to manage content on a content management server, according to various embodiments of the present disclosure. The user interface 1100 can be made available to the various users of computing systems, telecommunications devices, or other systems for administration of content on a content management server, such as in the various networks previously described in conjunction with FIGS. 1 and 6-8. The user interface 1100 includes a plurality of tabs 1102a-c, labeled “My Friends”, “My Content”, and “My Calls”, respectively. The user interface 1100 as shown has the “My Content” tab 1102b active. The “My Content” tab 1102b includes a plurality of content regions 1104a-d corresponding to different categories of content available to be associated with that user's contacts. In the embodiment shown, the regions 1104a-d include a “My Videos” region 1104a, a “My Songs” region 1104b, a “My Photos” region 1104c, and a “My Applications” region 1104d. Each region 1104a-d displays thumbnail versions of video or image content corresponding to the piece of content stored on the content management server and associated with the user to whom the screen is presented. Each of the thumbnail content entries is associated with a source of content and a user, such that the content can be linked to a contact, as described below in conjunction with FIG. 12. If additional content is available for management within the various categories displayed, the regions 1104a-d can include links leading to additional user interfaces allowing more detailed content management options.

FIG. 12 illustrates a user interface 1200 that can be used to manage contacts loaded onto a content management server, according to various embodiments of the present disclosure. The user interface 1200 generally corresponds to the interface 1100, in that it includes a plurality of tabs 1202a-c, labeled “My Friends”, “My Content”, and “My Calls”, respectively. In the user interface 1200, the “My Friends” tab 1202a is active. The “My Friends” tab 1202a includes a display of a plurality of contact entries 1204a-d, each of which corresponds to a person from whom the user of the user interface 1200 typically receives phone calls (e.g. is in the user's address book of an associated telecommunications device). Each contact entry 1204a-d includes, in the embodiment shown, a content source selection field 1206 and a description selection field 1208. The content source selection field 1206 allows the user to associate, with each of his or her contacts stored on a server, a particular third party content source from which that contact's customized content can be drawn. In the embodiment shown, the content source selection field 1206 indicates that the source from which content is drawn is selected as Facebook. Other third party content sources, particularly those third party content sources which allow the user's contacts to customize content associated with them (such as those previously described), may be used as well by selecting those other available sources from the selection field 1206. The description selection field 1208 allows the user to customize a message which will be displayed to the user when the contact associated with the corresponding contact entry calls that user, using the personalized content delivery principles of the present disclosure. Each entry also generally includes a name, phone number, and optional picture.

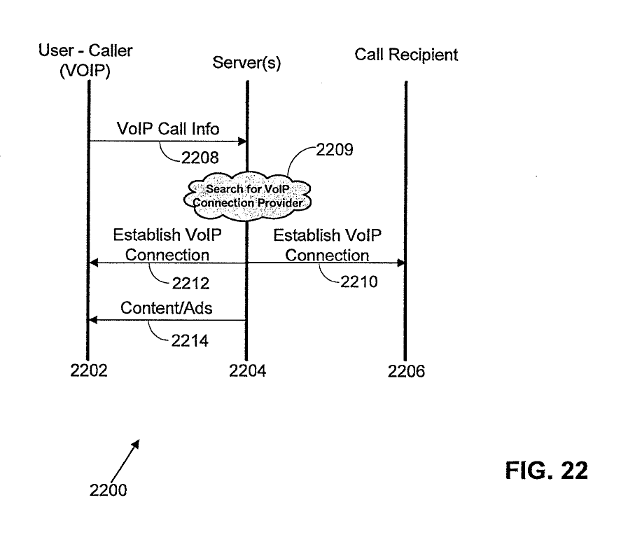

In certain embodiments, each entry also includes an indicator 1210 relating to voice over internet protocol connections (VoIP connections) available to each respective contact. These connections allow the user to call those contacts, when available, via the designated VoIP software client as designated in the user interface 1200. The indicator 1210 is user-adjustable, and may be changed manually or upon automatic update of contacts by uploading contact information to the content management server. Additional details regarding the sequence of placing such VoIP calls are described below in conjunction with FIG. 22.

It is therefore understood that, by using the user interfaces provided by the server portions of the present disclosure, the user can customize content displayed to that user by setting messages and sources of content with respect to each contact associated with that user. Furthermore, the present disclosure allows each of those contacts to automatically change the content that is displayed to the user by changing the content that they access, that being the content managed on third party content display sites/servers, such as MySpace, Facebook, Linkedin, or others.

Additional user interfaces may be incorporated into a web server, content management server, or other user-accessible management server which provide details and management access regarding various details of that user's account. For example, a further user interface logging calls which are routed to the content management server can appear in a user interface associated with the “My Calls” tab 1204c shown in the user interfaces 1100 and 1200 of FIGS. 11-12. Also, a user profile page indicating the user's preferences, and pages allowing the user to edit his/her profile can be incorporated into the system. Additionally, user interfaces may be provided relating to account billing, management, content and contact uploading and distribution and other options. Mobile versions of these administrative user interfaces may be provided as well, and include analogous functionality.

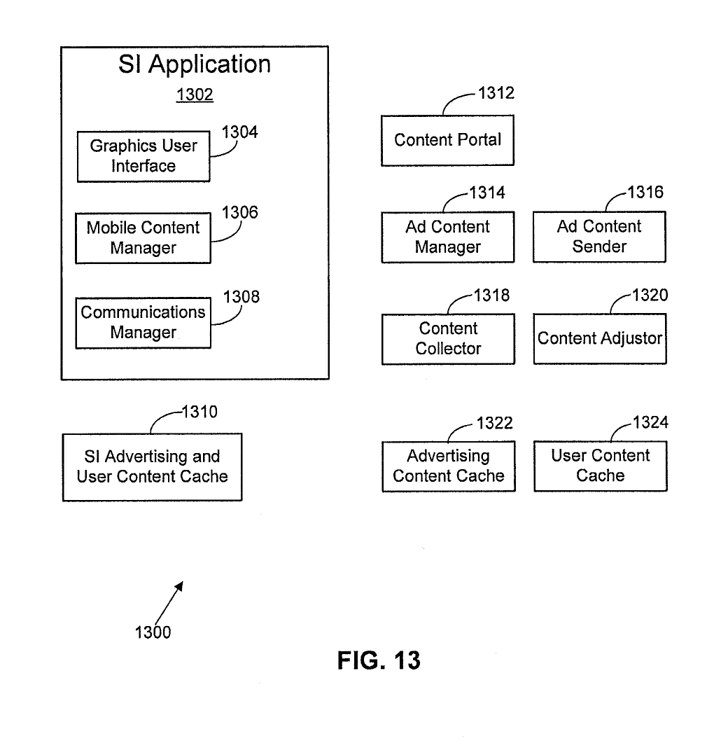

FIG. 13 illustrates a software system 1300 having certain content processing modules used to implement aspects of the present disclosure. The software 1300 includes generally a signal intercept application 1302 operable on a telecommunications device, as well as a plurality of server software modules, described below. In the various embodiments, the software system 1300 can be implemented in any of a number of languages and/or standards, such as by using .NET or C++ programming, or other programming constructs.

The signal intercept application 1302 is generally configured to obtain caller identification information, send requests for content using that caller identification information, and receiving and presenting that content in association with caller identification information upon receipt of an incoming call. The application 1302 includes a number of generalized software layers, each of which can perform differing functionality with respect to the operations of the software on a mobile telecommunications device. For example, in the embodiment shown, the signal intercept application 1302 includes a graphics interface 1304, a content manager 1306, and a communications manager 1308. The graphics interface 1304 provides an engine for displaying content and advertising on a display of a communications device. The graphics interface 1304 can include various functionality for formatting images and text to fit on the specific screen of the telecommunications device. The content manager administers content downloaded to the communications device, and can include a variety of functionality, for example including content caching, generating content requests, and other functionality. The communications manager 1308 manages communications with a content server, such as the content server and/or web server described above in FIG. 9. In various embodiments, the communications manager 1308 receives content requests from the content manager 1306 and communicates those requests to a server. The communications manager 1308 then receives content in response from the server, and provides it to the content manager 1306, which can then pass that content to the graphics interface 1304 for display to a user. Other divisions of functionality are possible within the software 1300 shown. Additional functionality can be incorporated into the SI application 1302 as well.

A cache 1310 maintains advertising and/or content on the communications device to minimize the need for wireless communications, reducing the latency between receipt of caller identification information and receipt of content from a server in some circumstances by storing a copy of typically-displayed content or advertisements locally.

A plurality of modules useable in the context of a server allow the software 1300 to respond to user requests relating to delivery of content and administrative tasks. The server modules include a content portal 1312, as well as an ad content manager 1314 and ad content sender 1316, a content collector 1318 and content adjustor 1320, an advertising content cache 1322 and a user content cache 1324. The content portal 1312 provides user access to content through fulfillment of inbound content requests from communications devices, such as the devices upon which the SI application 1302 is installed.

The ad content manager 1314 and ad content sender 1316 coordinate to select and delivery one or more advertisements to the communication devices connecting and requesting content, and can do so upon request of the content or on some preset, periodic basis. The ad content manager 1314 can select ads for delivery to communications devices by, for example, providing targeted advertising or general-audience advertising. In certain embodiments, the ad content manager 1314 and ad content sender 1316 perform various functionality as described above in conjunction with the advertising manager 936 and advertising database 938 of FIG. 9.

The content collector 1318 and content adjustor 1320 manage content acquisition and formatting for storage and delivery to telecommunications devices. In various embodiments, the content collector 1318 and content adjustor 1320 perform the functions described above in conjunction with the interface component 934, the formatting component 932, and the content script 930 of FIG. 9.

Additional software modules may be incorporated into the software systems 1300 of FIG. 13, such as to perform the additional logical functionality shown in the other figures and described elsewhere herein.

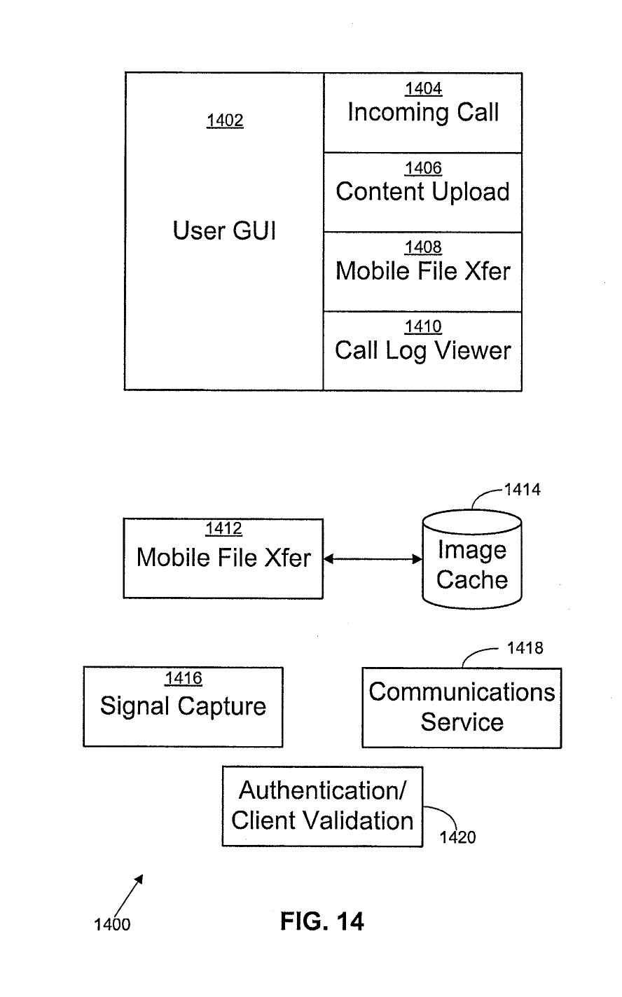

FIG. 14 illustrates a system 1400 including certain software modules resident on a telecommunications device implementing aspects of the present disclosure. The system 1400 can represent, for example, a specific implementation of a portion of the software 1300 of FIG. 13, such as a portion resident on a communications device and included within a signal intercept application.

The system 1400 includes a user interface 1402, which supports graphical components relating to an incoming call 1404, content upload 1406, file transfer 1408, and a log viewer 1410. The user interface 1402 presents various types of screens to a user, consistent with the various graphical components included therein. The incoming call component 1404 presents content and advertising to the user, the content being related to the caller identification information of the contact calling that user. The incoming call component 1404 displays information received from a server (or cached as previously received) in a web browser or other file display window operable using the user interface 1402. The content upload component 1406 provides an interface for uploading content stored on the communications device to a server, to make that content available for later download to other devices or for association with a contact upon receipt of a phone call from that contact.

The file transfer component 1408 provides an interface through which the user of the communications device can search for and access various files stored on the server or other computing systems interconnected via the data network to which the device is interconnected. In certain embodiments, the file transfer component 1408 provides a mobile file transfer interface for managing download of torrented files across a distributed data network. Other types of file transfer components can be implemented as well.

The log viewer 1410 presents a display to the user of various information tracked by the system 1400, which can include received incoming phone calls, outbound phone calls, content displayed and number of occurrences thereof, files transferred, content uploaded, and other file, content, or account administration activities performed.

Additional modules can be included in the system 1400 as well. In the system 1400 as shown, a mobile file transfer component 1412 is interconnected with an image cache 1414, and is operated by a user through use of the file transfer component 1408 of the user interface 1402. The mobile file transfer component 1412 provides the functionality to enable file transfers, such as managing torrented file receipt and assembling/organizing received files. An image cache 1414 stores the files received and compiled by the mobile file transfer component 1412.

Further modules, including a signal capture module 1416, a communications service module 1418, and an authentication module 1420 can be included in the system 1400. The signal capture module 1416 detects incoming phone call information and captures the ring or data signal, as well as caller identification information. The signal capture module 1416 optionally suppresses the ring signal until content is received and ready for display alongside the ring signal. The communications service module 1418 manages connection between the software systems of FIG. 14 and the native software systems resident on the communications device, such as the operating system of a cellular telephone or smartphone. The communications service module 1418 monitors the communications services (i.e. voice or data services) to ensure the existence of voice and data communications connections for uses by the system 1400 consistent with the methods described herein. For example, the communications service module 1418 monitors voice signal strength and monitors the connection to the data network (e.g. EDGE, GSM, UMTS, GPRS, CDMA, etc.) to verify that, upon receipt of an indication of an incoming call, a message can be sent on the data network to a content server requesting content relating to the contact associated with the incoming call, as identified by received caller identification information. The authentication module 1420 receives user entry of credentials (e.g. a username and password) for use with a server such as a content server, and stores those credentials for use in requesting data from that server. For example, the credentials may be sent alongside incoming caller identification information to allow the content server to which the message is sent to validate that the message is from a currently subscribing user having an active account prior to responding with content to the message. Other uses for the authentication module 1420 are possible as well, such as use in securing the software 1400 locally on the communications device, preventing others having access to the device from also accessing the settings within the software 1400.

Additional functionality can be incorporated into the software 1400 as well, depending upon the specific needs or options required by the software. For example, a dedicated local advertising manager module may be used to manage cached advertisements on the device, or a local content manager may manage cached content as well.

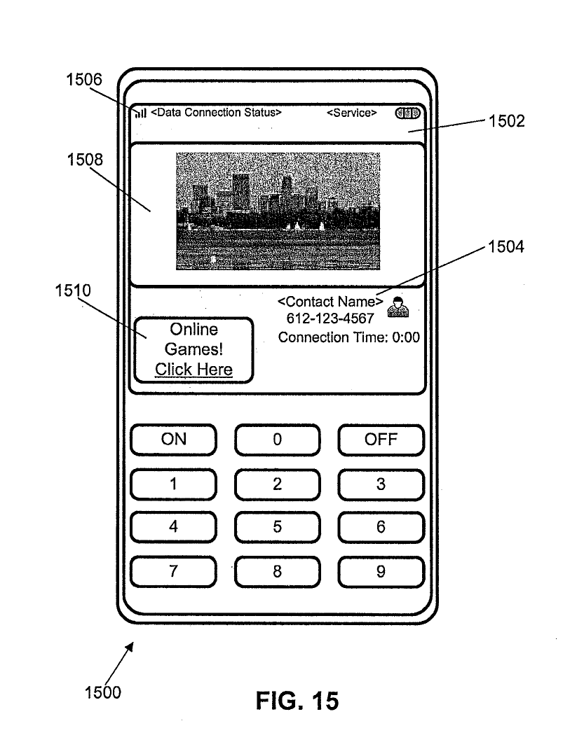

FIG. 15 is a schematic view of a telecommunications device 1500 according to an example embodiment of the present disclosure. The telecommunications device 1500, as shown, is in the process of receiving personalized content delivery in conjunction with an incoming telephone call. The telecommunications device as shown is a smart phone capable of both voice and data communications; however, any of a number of other telecommunications devices as previously described can be used in accordance with the present disclosure.

In the specific embodiment shown, the telecommunications device 1500 includes a display 1502 which illustrates a pending incoming telephone call. The display 1502 includes caller identification information 1504, status information 1506, a content region 1508, and an advertisement region 1510. The caller identification information 1504 generally includes the phone number from which the incoming call is being received. The caller identification information 1504 can also include the name of the caller, and other information. The status information 1506 corresponds to status information typically presented to a user on a display 1502 of the telecommunications device, and can include data and voice connection strength and status information, battery capacity and remaining power information. Other information may be included as well.

The display 1502 includes a content region 1508, which corresponds to a region of the screen allocated to display customized content on the telecommunications device 1500. The customized content corresponds to content selected on a third party content management or social networking website or service, as linked to by a content management server using the automated processes and user interfaces described above. The content region 1508 displays a visual portion of the content to be presented to the user, and can in addition be accompanied by audio or other content. An advertising region 1510 can optionally also be incorporated onto the display concurrently with the content, or may be alternated with the content at pre-specified times based on operation of a background application (e.g. the signal intercept application of the present disclosure). The advertising region 1510 can display text or graphical ads, and can optionally include links to additional online content or product information. The advertising region 1510 may vary in size or position based on a number of factors, such as the nature of the advertisement (text or graphical), the size of the content accompanying the advertisement, the order of display of the content and the advertisement, or how well targeted (e.g. through usage analytics) the ad is to the particular user receiving it.

Although a particular layout of the system is disclosed in the user interface 1500, the locations of the various regions may differ in various embodiments of the present disclosure. In certain embodiments, such as where the content selected for delivery corresponds to audio or other non-visual content, that content may not have a corresponding content region 1508 of the display, or may display a corresponding image to the non-visual content being presented to the user.

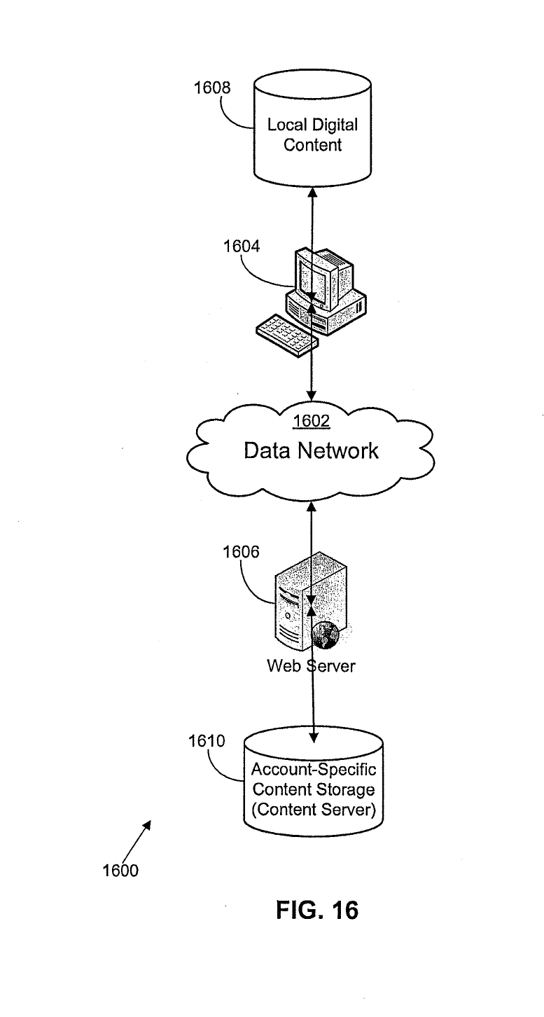

FIG. 16 illustrates a portion of a network 1600 used for providing or receiving personalized content, according to an embodiment of the present disclosure. In certain embodiments the network 1600 of FIG. 16 illustrates a portion of the networks described above that is used for uploading of digital content to a web or content server for use in connection with the personalized content delivery systems and methods described herein. The network 1600 includes a data network 1602 interconnecting a computing device 1604 and a web server 1606. The data network 1602 can be any of a number of types of data networks, such as a typical internet connection or any of the types of data networks previously described. The computing device 1604 is generally a client computing device capable of connection to the server 1606 via the network 1602, and can be, in various embodiments, a communications device as previously described or a general purpose computing device as described in conjunction with FIG. 3. The web server 1606 can be a web server as previously described, and can also include various other servers or computing devices, such as the content server described above.

A local content storage 1608 is interconnected with the computing device 1604, and represents local content that is accessible to the computing device 1604 and which is to be uploaded to the web server 1606. The local content storage 1608 can be resident in a memory of the computing system 1604, or can be on another computing system or communications devices communicatively linked to that device. Similarly, an account-specific content storage 1610 is interconnected with the web server 1606, and represents content that is accessible to the web server 1606 (as well as associated content servers, etc. used in accordance with the present disclosure). The account-specific content storage 1610 is generally received from computing devices, such as the computing device 1604, by transferring content from the local content storage 1608 to the account-specific content storage 1610 accessible to the server 1606. The account-specific content storage 1610 represents content received from one or more local content storage systems, and stores each set of received content in association with its source to ensure that received content is properly associated with its source.

The various content held and managed in the account-specific content storage 1610 can be put to a variety of uses, consistent with the methods and systems of the present disclosure. For example, the content can be associated with the subscribing user, and can be displayed in association with incoming calls from that user to other subscribers associated with the server 1606. Or, the content can be associated by the subscribing user to his or her contacts, thereby allowing the content to be displayed to the user when he or she receives an incoming phone call from those contacts, based on caller identification information. Or, the content can be made available for download by the user or that user's contacts that are also subscribing users having access to the content on the server 1606, such as through use of a file download or transfer application resident on a computing system or communications device. Other possibilities exist for uses of the content as well.

### C. Specific Implementations of Methods and Systems for Personalized Content Delivery

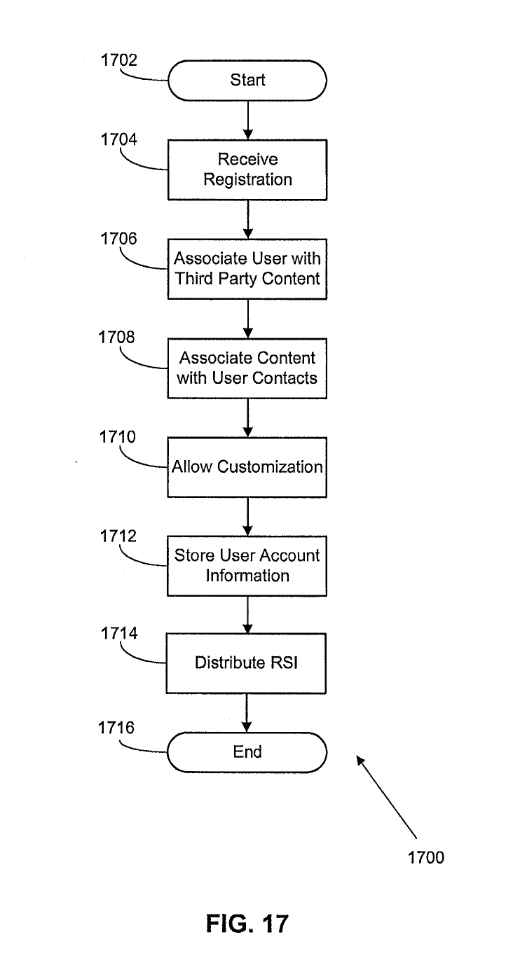

FIGS. 17-22, described below, are intended to provide a few specific examples of methods and systems for personalized content delivery within the general framework of the systems described in FIGS. 1-16, above. Although these specific systems illustrate some of the methods of delivering content according to the present disclosure, it is understood that additional and equivalent methods are possible as well, and are encompassed within the scope of this disclosure.

FIG. 17 is a flowchart of systems and methods for associating content with a user, according to an embodiment of the present disclosure. The system 1700 disclosed corresponds to initial set-up tasks occurring when a user registers with a content management server, such as in the systems of FIG. 1 or FIG. 9. The system 1700 is instantiated at a start operation 1702, which corresponds to the user initially visiting a website allowing that user to associate content with contacts according to the various embodiments of the present disclosure. Operational flow proceeds to a registration module 1704, which corresponds to presentation to the user of a registration form and receipt of user information, such as a username and password, payment information, and a listing of contacts (e.g. names, addresses, telephone numbers, etc.) with which the user would like to associate personalized content.

Operational flow proceeds to a user association module 1706. The user association module 1706 associates the newly subscribing user with one or more third party content sites, from which content can be drawn which relates to the user's contacts obtained during the registration module 1704. For example, the user association module 1706 can include generating a user interface for requesting information about the identity of websites upon which such content may exist, as well as requesting the user's credentials for accessing that content (e.g. the user's username and password for access of third party content).

Operational flow proceeds to a content association module 1708, which corresponds to associating content with one or more contacts associated with the user. The content association module 1708 associates content from third party websites, such as websites for which (1) the user has provided their authentication credentials and (2) for which the user is a subscribing user and in which the same user is associated with a number of other users, at least some of which are that user's contacts. The content association module 1708 determines that the contacts on the website correspond to the contacts obtained during operation of the registration module 1704, and associates the content stored on the third party website in association with that contact on a content server in connection with the corresponding contact of the subscribing user. In certain embodiments, the content association module 1708 corresponds to automatic operation of various of the content collection and adjustment modules described above in conjunction with FIGS. 9-10 and FIG. 13.

Operational flow proceeds to a customization module 1710. The customization module 1710 corresponds to an optional manual association component which can be used after the automatic content association to alter the content associations made in the content association module. This can be done, for example, by generating and presenting a user interface (e.g. via a web server to a subscribing user on a communications device or on a general purpose computing system) to display the correspondence of content and contacts, and allowing the subscribing user to modify associations made during the automatic content association module 1708.

Operational flow proceeds to a storage module 1712. The storage module 1712 stores content, contacts, and associations between the content and contacts as imported or otherwise obtained during operation of the modules 1704-1710. The storage module can store the content, contacts, and associations in a memory of a content server, such as in the content storage components of FIGS. 9-10 and FIG. 13.

Operational flow proceeds to an application distribution module 1714. The application distribution module 1714 provides to a user an application for accessing the content stored on a content server, such as prepared using the modules 1702-1712, above. In various embodiments, the application distribution module 1714 distributes a signal intercept application, such as the signal application of the various embodiments described herein. Operational flow terminates at an end operation 1716, which corresponds to completed setup of the system for personalized content distribution.

Additional modules may be included in the system 1700, and the various modules may be executed in differing order than the order in which they are described herein. For example, the application distribution module 1714 is not logically related to the other modules, and can be performed at any point throughout the system 1700. Other system modules may be reordered as well.

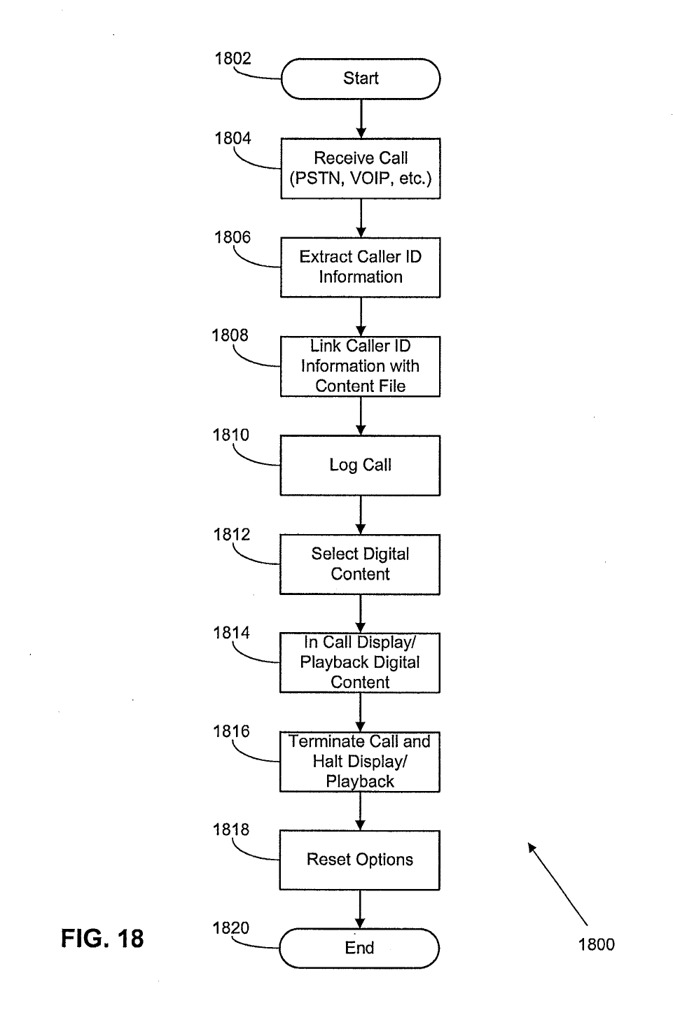

FIG. 18 is a flowchart of systems and methods for personalized content delivery to a telecommunications device, according to a further embodiment of the present disclosure. The system 1800 corresponds to typical operations occurring during the process of receiving a call over a voice or data network by a user having a communications device. The system 1800 can be performed, for example, using the systems and software described above in FIGS. 1-16.

The system 1800 is instantiated at a start operation 1802, which corresponds, in various embodiments to having a telecommunications device and an account set up to receive phone calls and associate content with the identified caller. Operational flow proceeds to a call receipt module 1804, which corresponds to initial receipt of a phone call on either a voice network (e.g. PSTN) or a data network (e.g. through VoIP). Operational flow proceeds to a caller information module 1806, which corresponds to interception of caller identification information received in conjunction with ring and/or data signals, such as by a signal intercept application. The caller information module 1806 further includes generating a request for content associated with the caller identification information, including (1) the user's authentication information and (2) the caller identification information received by the user's communication device. Other information may be included in the request as well.

Operational flow proceeds to a link module 1808. The link module 1808 links the caller identification information to content, such as by a server receiving a request from a communication device including caller identification information relating to a contact. In various embodiments, the link module 1808 links to a third party server, such as a third party social networking application server such as Facebook, LinkedIn, Orkut, MySpace, or other systems, to automatically obtain content relating to that contact.

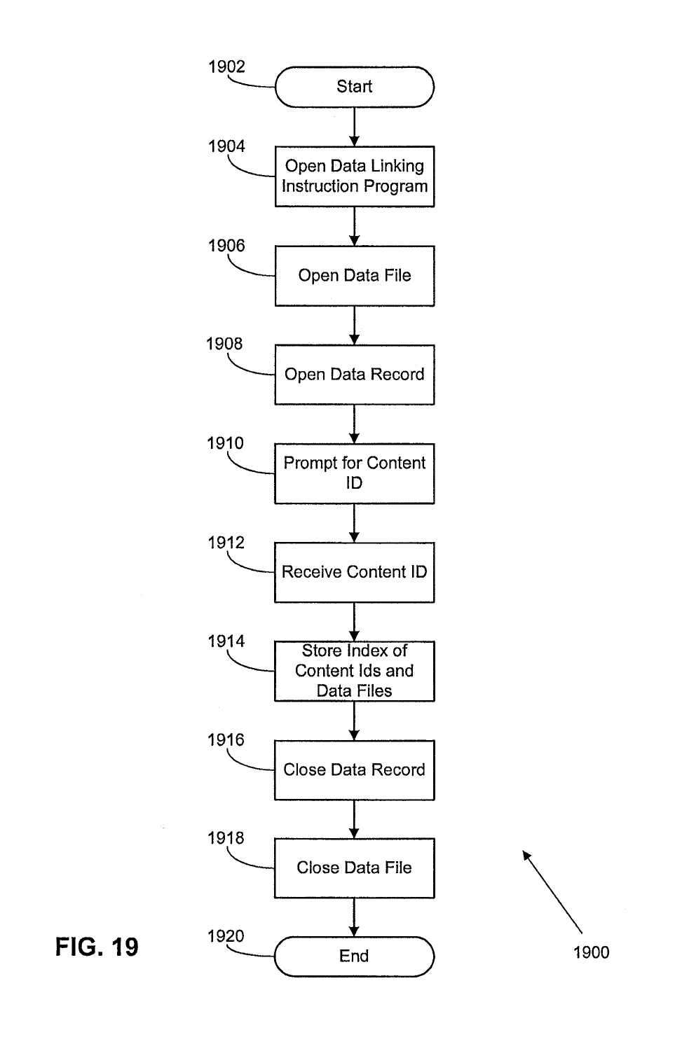

In certain embodiments, the link module 1808 has previously been executed (e.g. in a setup procedure such as the setup system 1900 of FIG. 19), and may optionally be run to update content. In further embodiments the link module 1808 attempts to avoid querying a third party server while the communications device has a pending inbound call to reduce latency, such as when a content server already has collected content recently from the relevant third party system.

Operational flow proceeds to a log module 1810. The log module 1810 creates a log of the content collected from the third party servers, such as by caching the content on a content server. Operational flow proceeds to a content selection module 1812. The content selection module 1812 receives the caller identification information extracted during operation of the caller information module 1806 on a user's communication device, and selects content from among content previously associated with a contact relating to the caller identification information. Although methods by which content selection may vary, in certain embodiments a round-robin selection scheme is employed to ensure that each time a phone call is received from the contact, different content relating to that contact is displayed. Other content selection methodologies can be used as well.

Operational flow proceeds to a presentation module 1814. The presentation module 1814 operates on the user's communication device to present the content selected using the content selection module 1812 and provided to the communication device. In various embodiments of the presentation module 1814, the content is displayed, in conjunction with advertising and the incoming caller information. In various embodiments, the presentation module 1814 can present the content on a display of the user's communication device in a variety of formats; in one embodiment, the content is displayed within a web browser window substantially centered in the display.

Operational flow proceeds to a termination module 1816. The termination module 1816 corresponds to ending the display of content, advertising, and caller identification information. In certain embodiments, initiation of the termination module 1816 to end display of these items corresponds to ending of the voice call relating to the contact with whom the content is associated. In further embodiments, the termination module 1816 executes after an elapsed time, once the call has been answered. Other timing possibilities are possible as well.

Operational flow proceeds to a reset module 1818. The reset module 1818 corresponds to resetting various operational parameters within the system 1800, such as the various call and content display parameters. Operational flow terminates at an end operation 1820, which corresponds to completed processing of the received telephone call.

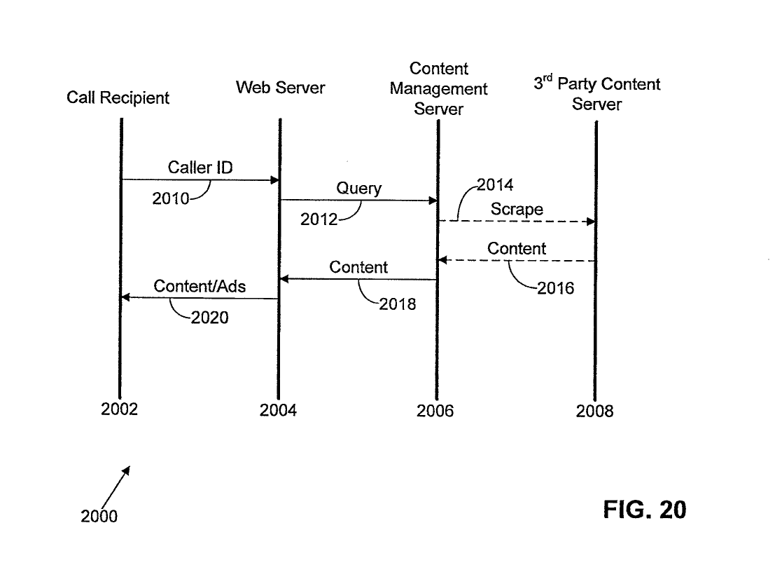

Other modules may be incorporated into the system 1800 overall, such as modules providing display of additional information, such as advertising, user license agreements, or other information. Furthermore, the modules may be executed in a different order, and no specified order is dictated by the order described herein other than the typical ordering inherent in a telephone call. For example, the log module 1810 may execute at any point in the process flow of the system, or the presentation module 1814 can cease execution at various times during a phone call. Additionally, certain of the modules may be excluded from operation within the system 1800 overall, and may be performed in conjunction with other systems such as the system 2000 of FIG. 20. Other possibilities exist as well.

FIG. 19 is a flowchart of systems and methods for associating content with contacts, according to an embodiment of the present disclosure. The system 1900 generally corresponds to a specific set of operations performed on a content management server, such as the server operations of FIGS. 1 and 9, for linking caller identification information and contacts to content cached on the content management server. The system 1900 is instantiated at a start operation 1902, which corresponds to receipt of a request for content from a telecommunications device, including receipt of caller identification information.

Operational flow proceeds to a data linking module 1904. The data linking module 1904 operates on the content management server, and acts to open a data linking instruction program resident on the server.

Operational flow proceeds to an open data file module 1906. The open data file module 1906 opens a data file which stores a number of contacts associated with a subscribing user to a content management server. The contacts stored in the data file module 1906 are generally contacts previously received from the subscribing user, and will generally include name, phone number, and other identifying information relating to individuals who frequently call that user.

Operational flow proceeds to an open data record module 1908. The open data record module 1908 opens a data record associated with the subscribing user, the data record including a record of content available to the system which is linked to one or more of the contacts in the data file. Operational flow proceeds to a prompt module 1910, which prompts a user or system for a content identifier, the content identifier corresponding to an identity of a location at which content can be collected. For example, the prompt module 1910 can request input by a user of locations, addresses, and authentication information for third party content locations with which that user has accounts. Operational flow proceeds to an identifier receipt module 1912, which corresponds to receipt of the content identifier information requested by the prompt module 1910.

Operational flow proceeds to an index storage module 1914, which stores an index of content identifiers and data files associated with those content identifiers. The index storage module 1914 manages the index, which provides a possible method by which content and contacts are lined in the present disclosure. By storing the indexes, content and contacts are automatically associated, and the index can be accessed upon receipt of a request for content including identifying information of one of that user's contacts. Operational flow proceeds to a close data record module 1916, which saves and closes the data records, and to a close data file module 1918, which saves and closes the data file. Operational flow terminates at an end module 1920, which corresponds to completion of the data associations and readiness to receive requests for content.

In certain embodiments, the system 1900 automatically links the content acquired from the various linked sources to contacts of a subscribing user of the system, such that the content associated at those sources with individuals corresponding to the contacts is linked to the contacts. In further embodiments, the system 1900 allows the subscribing user to modify the automatically linked content-contact links, such as through use of additional modules and/or user interfaces, such as described above in conjunction with FIG. 19.

Furthermore, in certain embodiments, the system 1900 can additionally store the content itself in addition to the index to the content. In such systems, the content can be cached on a content management server, such as described above in FIG. 9. Other caching possibilities are possible as well.

FIG. 20 illustrates a logical process flow 2000 of a phone call initiated over a voice or data network and implementing aspects of the present disclosure. The process flow 2000 shows communication links among various devices, including, for example, a call recipient 2002 (e.g. a subscribing user's communication device, such as a smartphone), a web server 2004, a content management server 2006, and a third party content server 2008. The communication links illustrate communicative messages passed among the various devices upon receipt of an incoming voice call at the call recipient, such as via PSTN or VoIP communication.

A caller ID message 2010 is passed from the call recipient 2002 to the web server 2004. The caller ID message 2010 includes identification information for both the caller and the call recipient. In the embodiment shown, the call recipient information includes the username and password of the call recipient to verify to the web server 2004 that the call recipient is a subscribing user of the service provided by the web server and content management server 2006.

The web server 2004 receives the caller ID message 2010 and generates a query message 2012 to be sent to the content management server 2006. The query asks the content management server for content relating to the contact associated with the caller identified in the caller ID message 2010. The web server 2004 filters caller ID messages such that unauthorized users cannot directly query the content management server 2006.

The content management server 2006 may or may not have content cached thereon. If it does not have any content associated with the received contact (as identified by the caller identification information), the content management server 2006 executes a script to generate and transmit one or more scraping messages 2014 targeted toward one or more third party content servers 2008. The scraping messages 2014 request all content associated with the subscribing user, or at least that information associated with both that subscribing user and the currently calling contact. In response to the scraping message, the third party content server 2008 returns content 2016 to the content management server 2006.

The content management server, once it has content in response to the query 2012 (either by caching or by the scraping message 2014 and the content return 2016), generates a content message 2018 to be sent to the web server 2004. The content message sent to the web server 2004 is combined with relevant advertising, and sent as a content package 2020 to the call recipient. The content package is unpacked by the call recipient 2002, and displayed as described in the various embodiments above.

FIG. 21 illustrates a logical process flow 2100 of a phone call initiated over a data network and implementing aspects of the present disclosure. The logical process flow illustrates links analogous to the links of FIG. 20, but are arranged to accept connections via a data network, such as from a computer connecting directly via VoIP to the call recipient. The embodiment shown relating to the logical process flow 2100 corresponds to a VoIP or equivalent type of voice call over a data network in which a widget is used. In the embodiment shown, the widget is configured for direct access to the content management server 2006. In the embodiment shown, a call sender 2102 is pictured, and corresponds to a user of a widget-enabled computing device configured to use VoIP calling over a data network, such as the internet, in conjunction with a call routing server. Typically, widget-based VoIP systems allow the caller to click on an online widget, causing a data interface screen to appear. The caller will enter self-describing details, which in this case take the place of the caller identification information. The widget sends this information to an intermediate server, which in turn obtains the information and establishes a VoIP connection with the party being called (in this case, the user of the personalized content delivery system). Upon establishing connection with the user, the server then establishes a VoIP connection with the caller.

In the embodiment shown, the call sender 2102 targets the call recipient, but is configured to route messages to the call recipient by sending a call initiation message 2104 to a content management server. The call initiation message 2104 includes the caller identification information and recipient information, so the content management server 2006 can associate content with the call sender 2102 and send the content message 2018 to the web server 2004. The web server can then send the content package 2020 to the call recipient, analogously to the flow described in FIG. 19, above.

In certain embodiments, the server that is associated with the widget is also the content management server, such that the content management server is also responsible for initiating VoIP connections between the user's telecommunication device (i.e. the device associated with the call receiver) and the computing device upon which the widget is running (i.e. the device associated with the caller).

Although not shown, if the content management server 2006 does not have content associated with the contact for the subscribing user, the scrape 2014 and content 2016 messages may still be required when used in conjunction with the VoIP widget implementation described herein. It is seen in FIG. 21 that through use of such a direct VoIP inbound connection through use of such a widget, a substantial length of the inter-device communication process flow can be avoided by eliminating the need for the messages 2010-2012. However, in certain embodiments, the widget user is required to be a subscribing user of the content management server 2006.

Referring now to FIG. 22, a further example of a VoIP call process 2200 is shown, in which the user associated with the content management server makes an outbound telephone call using VoIP. In the embodiment of the process 2200 shown, a user 2202 of a telecommunications device places an outbound call over a data network by communicating an intended contact to call to a server 2204, such as the content management server or web server of the present disclosure. The call is intended to be routed through the server 2204 and to a call recipient 2206, who may or may not be associated with the content management server or web server as previously described. The user 2202 presses a “start” button, such as is typically available on a telecommunications device, and software resident on the user's telecommunications device routes entered call information 2208 to the server 2204. In certain embodiments, this software corresponds to a component of the signal intercept software previously described herein. The server 2202 receives the contact information, and determines whether a phone call can be made using a VoIP client, such as by performing a search process 2209. For example, the content management server can access the user account to determine which of a variety of VoIP client systems the selected contact uses (as denoted in the user interface of FIG. 12, above). Optionally, if additional VoIP clients are associated with each user, the process may include polling the various VoIP clients, using IP calls to the various websites of VoIP providers, to determine if a voice connection can be established (e.g. whether the contact is “online” or available for a call). Once the server determines an available routing for the VoIP call, the server 2204 will establish connections 2210, 2212, respectively, with both the user and the intended client using the selected protocol. While the phone call occurs, the server systems of the present disclosure can deliver content (and optionally advertisements) 2214 for display to the user in conjunction with that associated contact receiving the call, consistent with the methods and systems for personalized content delivery described herein.

In certain embodiments, the person being called 2206 by the user 2202 need not be a preloaded contact associated with the user in the content management server. In such cases, the user 2202 is prompted on his/her telecommunications device (such as by a module incorporated into the signal intercept application described above) to enter a number for the IP call. When that number is received by the server, it can append additional digits as necessary, and can poll available VoIP clients available to the server to determine whether such a connection is available.

Through use of the VoIP connection systems described herein, a user can avoid many dialing errors, and can reduce the time required to find correct dialing information by allowing a server system to automate a large portion of this activity. This greatly saves the user time, effort and reduces dialing errors by hunting down the available VoIP line.

Although FIGS. 17-22 illustrate specific examples of usages of the systems, data, and methods of the present disclosure, it is understood that additional methods and variations are possible as well. Furthermore, referring now to the system in general it is observed that a number of advantages are provided by way of the methods and systems for providing personalized digital content. For example, in the majority of the methods and systems described herein require only the call recipient to be a subscribing user of the content delivery systems described herein. Furthermore, the methods and systems of the present disclosure use a variety of third party content aggregation sites in which content and individuals are associated; as these websites are changed by those individuals, subscribing users to the present system receive updated content without user intervention through periodic scraping processes and monitoring of the third party websites. Additionally, an advantage the present disclosure has over prior art systems is that it offloads certain content processing (linking, formatting, etc.) tasks to a central server, while also allowing the majority of digital content to remain at third party content aggregation sites, allowing a subscribing user and his/her contacts to control the content displayed during an inbound call by controlling the content displayed at those sites.

Additionally, through the use of a Signal Intercept (SI) application and a location identification feature in SI software embedded on subscriber telecommunications devices, the methods and systems of the present disclosure support the capability, before the subscribing party answers or generates a voice call, to affix the subscriber's location, which is relayed via a SI automated outbound Internet Protocol (IP) data call to obtain signal signature confirmation and relay both the signal signature confirmation and location to a remotely located computer server that selects and transfers in real time, to the subscriber's telecommunications device, location specific digital content (including, but not limited to, rapid notifications and advertisements. By sending such location specific information before the call is answered, there is a significantly higher probability that the digital content (including, but limited to, rapid notifications, and advertisements) will be viewed by the called party because the information is delivered synchronously along with caller ID data. Other advantages are provided by the methods and systems of the present disclosure as well.

### D. Alternative System Architectures and Methods

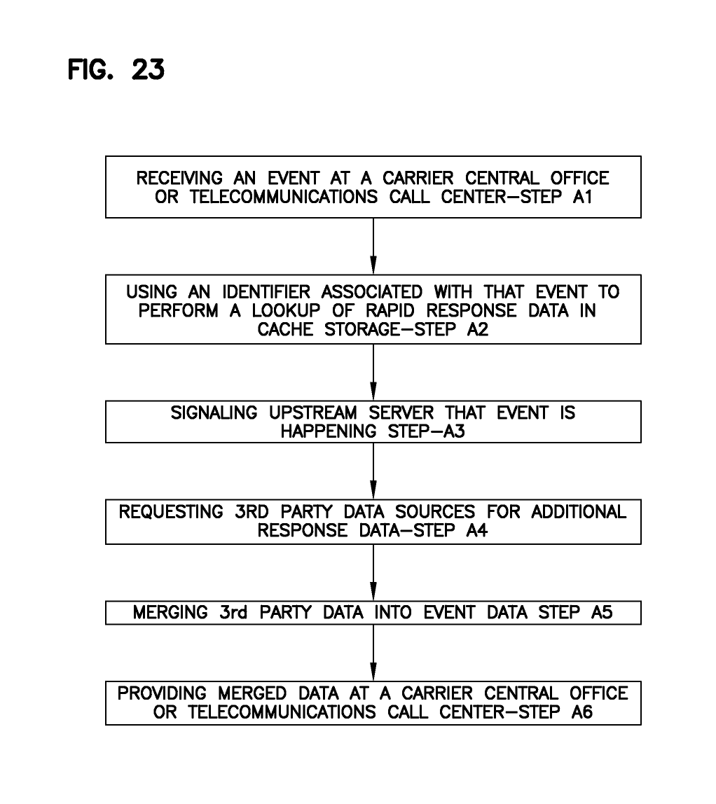

In order to facilitate description, the following discussion with FIGS. 23 through 28 will describe the present disclosure in terms of providing rapid response data, such as that in a call setup and termination inside of a call center or telecommunications carrier central office, during occurrence of a phone call. It will be understood to those of skill in the art, however, that aspects of the present disclosure also may be used during provision of other time-critical data. The disclosure should therefore not be taken as limited except as provided in the attached claims.

In general terms, the present disclosure is directed to a method of providing rapid response data services. An illustration of the general method is shown in FIG. 23, including the steps of: receiving an event at a telecommunications call center or telecommunications carrier central office (or other time-critical operator terminal or workstation or cell phone or personal digital assistant) (Step A1); using an identifier associated with that event to perform a look-up of rapid response data in an initial (such as local) storage (Step A2); signaling an upstream server that an event is occurring (Step A3); requesting third-party data sources for additional response data (Step A4); when third-party data is received, merging the third-party data into event data (Step A5); and providing merged data at a TELECOMMUNICATIONS CARRIER CENTRAL OFFICE CALLER ID SWITCH AND SUBSEQUENTLY TO CALL RECIEVER'S PDA or computer terminal (Step A6).

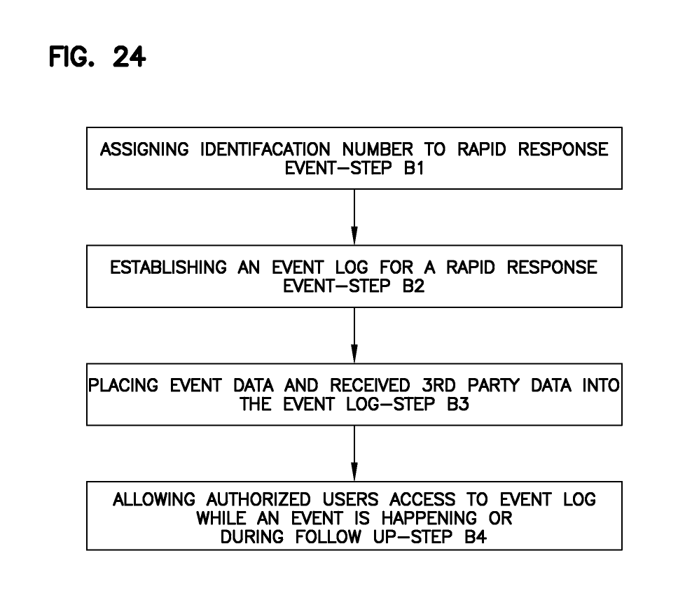

In specific embodiments, the disclosure provides additional features and services related to rapid events, as illustrated in FIG. 24, including the steps of: assigning an identification number to an rapid event (Step B1); establishing an event log for an rapid event (Step B2); placing event data and received third-party data into the event log (Step B3); and allowing authorized users to access said event log while an event is occurring or during follow-up (Step B4).

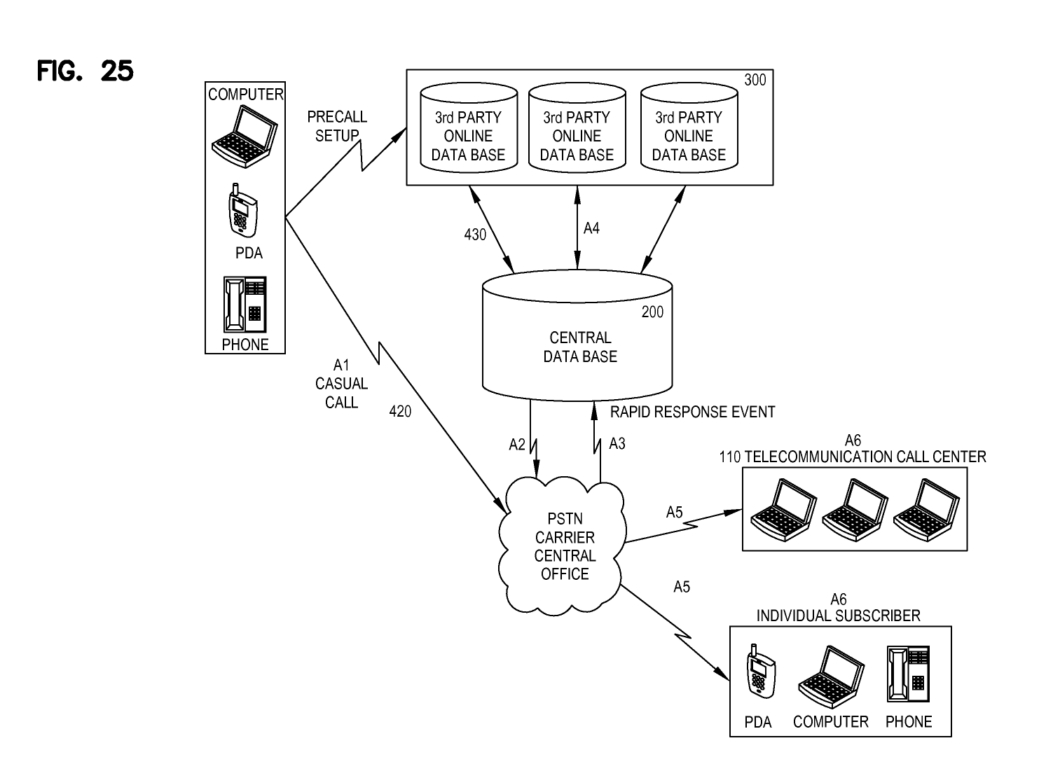

In a particular embodiment, the present disclosure can be understood as a system for exchanging information among users, third party information providers, and TELECOMMUNICATIONS CARRIER CENTRAL OFFICE CALLER ID SWITCHES AND SUBSEQUENTLY TO CALL RECIEVERS' PDAs. An example architecture for doing this is shown in FIG. 25.

In this example architecture, a local data store system 100 provides immediate response data to one or more TELECOMMUNICATIONS CARRIER CENTRAL OFFICE CALLER ID SWITCHES AND SUBSEQUENTLY TO CALL RECIEVER'S PDA or computer terminals 110. In particular embodiments, system 100 is used to locally store data assigned to its associated TELECOMMUNICATIONS CARRIER CENTRAL OFFICE CALLER ID SWITCH AND CALL RECIEVER'S PDA or computer terminal and to provide front line redundancy in the case that a connection to an upstream data store 200 is not available.

In specific embodiments, system 100 further forwards event data to upstream data hub 200, which handles additional data services as described below. The separation of the local data store 100 from the extended data services 200 is one important aspect of specific embodiments of the disclosure. While systems 100 and 200 could in fact be resident in a single physical computer system, their design and operation is such that the extended services provided by 200 do not delay the provision of data by 100.

In specific embodiments, an Authoritative Server may contain an authoritative version of stored subscriber data. Authoritative Servers may be location independent and many Authoritative Servers can hold the same subscriber information.

In specific implementations, at a TELECOMMUNICATIONS CARRIER CENTRAL OFFICE CALLER ID SWITCH AND SUBSEQUENTLY TO CALL RECIEVER'S PDA or computer terminal, there may also be a Local Redundant Data Store (LRDS), such as 100. Each LRDS will be configured to hold a local copy of the subscriber information that is assigned to the TELECOMMUNICATIONS CARRIER CENTRAL OFFICE CALLER ID SWITCH AND SUBSEQUENTLY TO CALL RECIEVER'S PDA or computer terminal. In specific embodiments, the LRDS will also hold a copy of query responses that were initiated from the TELECOMMUNICATIONS CARRIER CENTRAL OFFICE CALLER ID SWITCH AND SUBSEQUENTLY TO CALL RECIEVER'S PDA or computer terminal, even if that data is not generally assigned to that local redundant store.

Records in the LRDS may be updated from the Authoritative Server according to a variety of protocols, such as: based on age of records, updated whenever the records change at the Authoritative Store, or a combination of factors. The subscriber information that has been assigned to a particular LRDS will be refreshed on a periodic basis. In the event of a network outage, the TELECOMMUNICATIONS CARRIER CENTRAL OFFICE CALLER ID SWITCH AND CALL RECIEVER'S PDA or computer terminal will still have data available for rapid events.

In a specific embodiment, a TELECOMMUNICATIONS CARRIER CENTRAL OFFICE CALLER ID SWITCH, CALL RECIEVER'S PDA or Operator Terminal 110 will include a smart client that will interface with the Intelligent Server (ISS) software. The modular design will allow the same client software interface with most ISS platforms. In an alternative design, a TELECOMMUNICATIONS CARRIER CENTRAL OFFICE CALLER ID SWITCH and CALL RECIEVER'S PDA or operator terminal can access a LRDS through a standard browser.

In further specific embodiments, a system according to the disclosure includes a gateway specification that will guide third party providers to integrate their systems according to the disclosure. The gateway specification will maintain an open protocol and allow third party data providers to participate in the system.

In a further aspect, various embodiments of the present disclosure allow for communication with third party data providers 300 to provide additional rapid response data. A third party provider generally will be notified of a rapid event based on an in effect subscriber's agreement. In specific embodiments, a provider has the option to provide feedback which will appear in a subscriber's and/or an event log.

A third party also may be understood as a subscriber in situations where a subscriber is configured to provide real-time rapid response data. For example, a subscriber may be a social network that provides extensive response information. In these situations, a subscriber's database may operate within a system according to the disclosure as a third-party database.

It will be seen that in specific embodiments of the disclosure as implemented in a system as shown in FIG. 25, data is distributed hierarchically, with the local source providing the first response data.

In further aspects, queries made to a local source will automatically be forwarded to up-stream servers. Queries may be forwarded to multiple upstream servers for redundancy and to improve access speed.

In specific embodiments, data in a local source includes a “Data Expiration” option on a per server or, optionally, a per record basis. The Data Expiration value indicates when a data record becomes outdated and needs to be refreshed from an authoritative server. The Data Expiration value is specified on a server basis and can also be specified on a per record basis to accommodate fast changing data sources. In specific embodiments, the disclosure further provides a bulk query capability in the local source to allow it to bulk update records.

As indicated above, events may also be forwarded to third party data providers so they can provide feedback, e.g. a social network can specify additional record fields, data elements, or other types of data.

A further party that may be in communication with 200 is rapid response personnel, illustrated by 310. In particular embodiments of the disclosure, these personnel can provide live feedback that will appear in the subscriber log.

Subscriber notification and access to data is illustrated by 400. If a subscriber has elected to receive notification regarding an event, those notifications can be sent to one or more persons to one or more notification devices, as shown in 400 via a connection 410, which in some embodiments may be a one-way connection. In a further embodiment, a subscriber can access rapid data over a two-way connection such as 420 and learn such information.

According to various aspects of various specific embodiments, a system according to the disclosure includes architectural features to facilitate the rapid and effective provision of rapid response data. In a specific embodiment of the system shown in FIG. 25, for example, a consistent open data exchange protocol operates on connections 430. Such a consistent protocol allows for easy inclusion of third-party data during an rapid response.

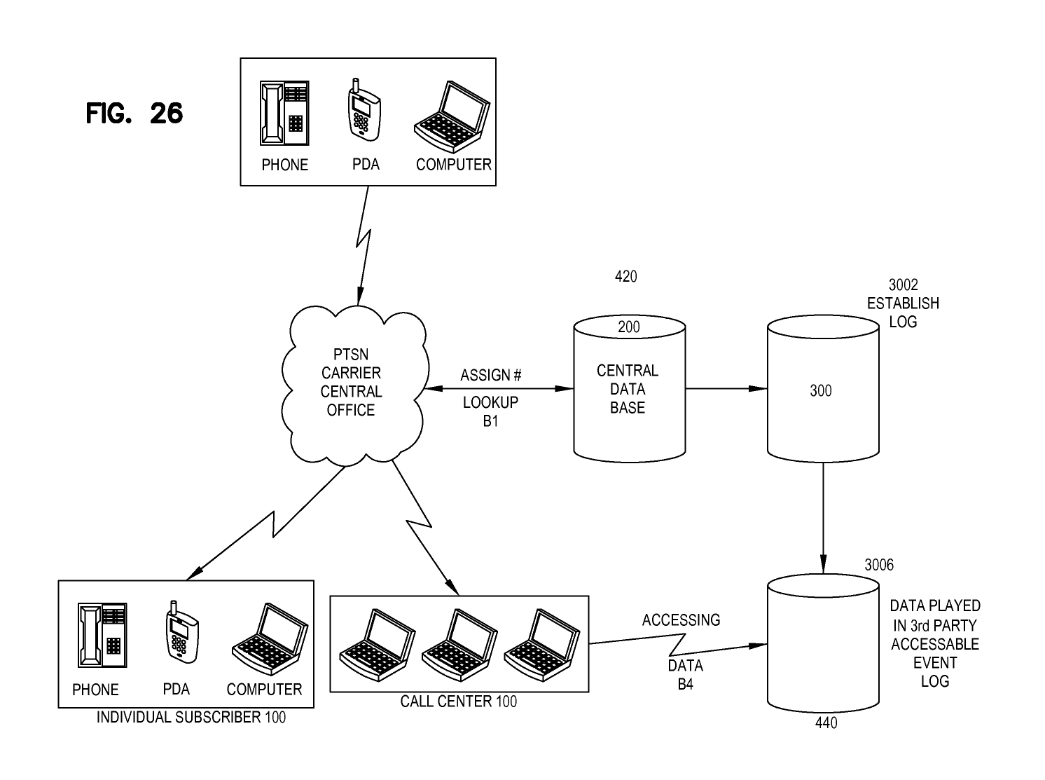

FIG. 26 is a block diagram showing an example system architecture data flow according to further specific embodiments of the disclosure. This figure illustrates a system according to the disclosure as a number of functional elements. In particular embodiments, third-party data resolution and other functions necessary for interface of a TELECOMMUNICATIONS CARRIER CENTRAL OFFICE CALLER ID SWITCH AND CALL RECIEVER'S PDA or computer terminal 110 may actually reside on the same computing device as local store 100 as a server client 100a. In such an embodiment, a TELECOMMUNICATIONS CARRIER CENTRAL OFFICE CALLER ID SWITCH AND CALL RECIEVER'S PDA or computer terminal 110 can communicate over a channel 440 with a server client 100a and client 100a handles communication to a secondary data store and third-party data. In this embodiment, such an architecture allows a TELECOMMUNICATIONS CARRIER CENTRAL OFFICE CALLER ID SWITCH AND CALL RECIEVER'S PDA or call center terminal to be an off-the-shelf type PDA, computer, terminal or workstation without custom software, but running a standard data exchange protocol over connection 440, such as an HTTP-type protocol. Preferable, this protocol will be capable of transferring multimedia data, such as HTTP/HTML. In one embodiment, TELECOMMUNICATIONS CARRIER CENTRAL OFFICE CALLER ID SWITCH AND CALL RECIEVER'S PDA or call center terminal 110 could therefore connect to 100a with a standard WWW browser.

In specific embodiments of the present disclosure, a particular underlying data format is used to enhance the operational and architectural features. In this data format, data is self-describing, meaning that data carries in it both its field values and the respective field names and/or field characteristics of those values.

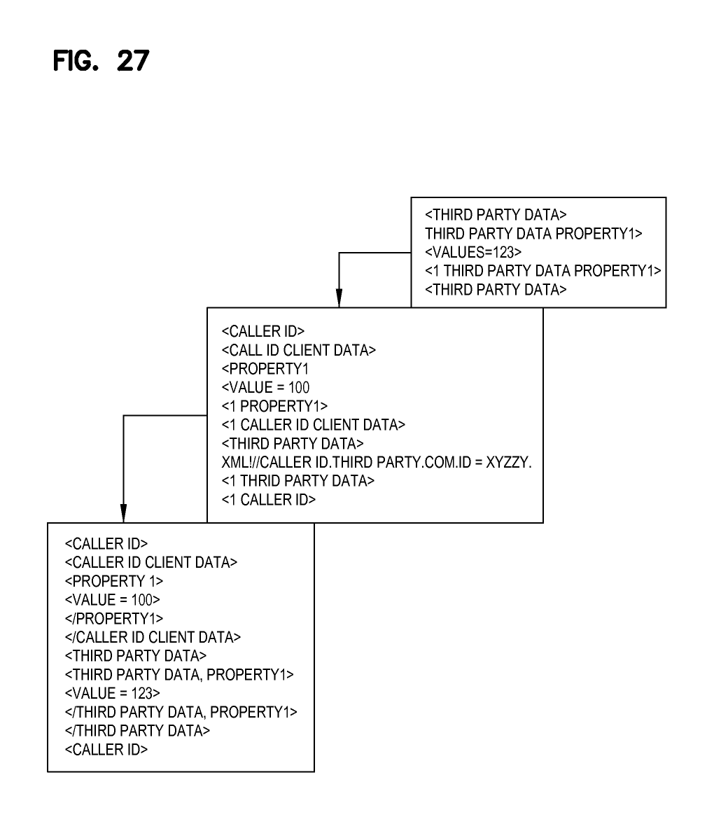

In a particular embodiment, this data structure is based on the eXtensible Markup Language (XML). A representation of an implementation based on XML is shown in FIG. 27. As indicated, in one embodiment, data at an intermediate upstream server holds a reference to the third party data. When an operator performs a query, the data reference can be resolved on-the-fly or can be delayed for on-demand lookup. The data, once retrieved, is merged into the primary data stream.

In particular embodiments, a system or method according to the present disclosure can incorporate a number of additional features or aspects to enhance provision of services as herein described.

In particular embodiments, the system of the present disclosure can use standard HTTP in a Request/Response protocol to communicate over various of its data channels, including third-party data and log-data provided to subscribers. This allows the disclosure to fully utilize existing internet routing infrastructure for these channels, thereby increasing flexibility of access and reducing costs. The data exchange further may be secured using with standard security protocols such as SSL or SSH.

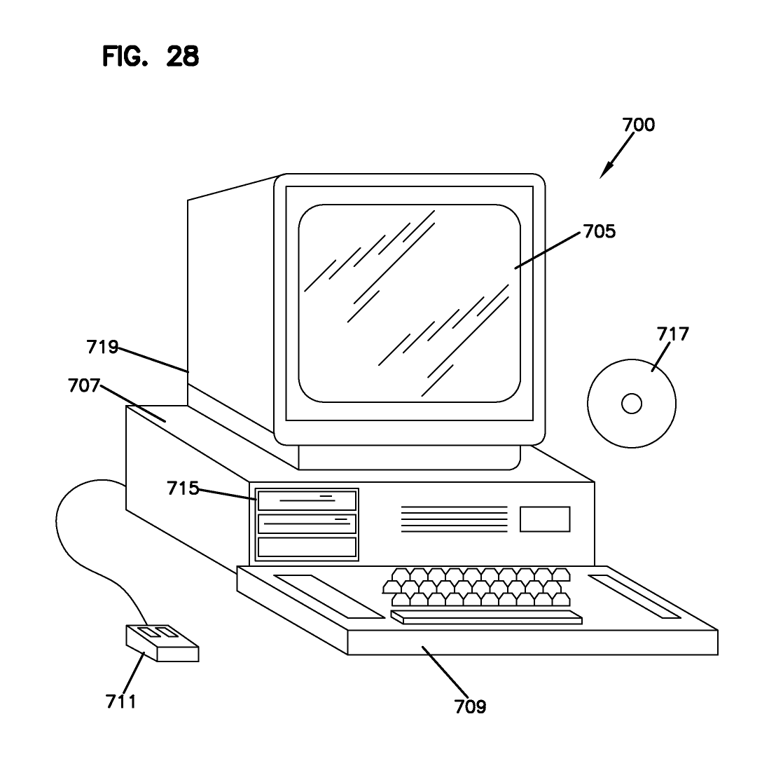

FIG. 28 is a block diagram showing a representative example logic device in which systems of the present disclosure may be embodied. The systems and methods of the present disclosure can be implemented in hardware and/or software. In some embodiments, different aspects can be implemented in either client-side logic or a server-side logic. As will be understood in the art, the systems of the present disclosure, or components thereof, may be embodied in a fixed media program component containing logic instructions and/or data that when loaded into an appropriately configured computing device cause that device to perform according to the disclosure. As will be understood in the art, a fixed media program may be delivered to a user on a fixed media for loading in a users computer or a fixed media program can reside on a remote server that a user accesses through a communication medium in order to download a program component.

FIG. 28 shows an information appliance (or digital device) 700 that may be understood as a logical apparatus that can read instructions from media 717 and/or network port 719. Apparatus 700 can thereafter use those instructions to direct server or client logic, as understood in the art, to embody aspects of the present disclosure. One type of logical apparatus useable to implement the present disclosure is a computer system as illustrated in 700, containing CPU 707, optional input devices 709 and 711, disk drives 715 and optional monitor 705. Fixed media 717 may be used to program such a system and may represent a disk-type optical or magnetic media, magnetic tape, solid state memory, etc. The disclosure may be embodied in whole or in part as software recorded on this fixed media. Communication port 719 may also be used to initially receive instructions that are used to program such a system and may represent any type of communication connection.

Additionally, an application specific integrated circuit (ASIC) or a programmable logic device (PLD) could be used to implement aspects of the present disclosure. In such a case, a computer understandable descriptor language can be used to create an ASIC or PLD that operates as herein described.

Although the present disclosure describes particular embodiments, other embodiments will be apparent to those of skill in the art. In particular, a user digital information appliance has generally been illustrated as a telecommunications device such as cell phone or personal digital assistant. However, the digital computing device is meant to be any device for interacting with a remote data application, and could include such devices as a personal computer, digitally enabled television, or other system.

Also, channels have been described primarily as traditional phone lines or network connections, with the appropriate corresponding hardware. However, channels are meant to be any channels capable of carrying data, including wireless channels, optical channels, and electrical channels.

Furthermore, while the present disclosure has in some instances been described in terms of client/server application environments, this is not intended to limit the invention to only those logic environments described as client/server. As used herein, “client” is intended to be understood broadly to comprise any logic used to access data from a remote system and “server” is intended to be understood broadly to comprise any logic used to provide data to a remote system.

It is understood that the examples and embodiments described herein are for illustrative purposes only and that various modifications or changes in light thereof will be suggested by the teachings herein to persons skilled in the art and are to be included within the spirit and purview of this application and scope of the following claims.

1-30. (canceled)

31. A method of providing rapid response information comprising:
receiving a request for rapid response data;
retrieving the rapid response data from initial storage;
initiating one or more requests for third-party data based on the rapid response data, the one or more requests for third-party data using an open protocol data structure; and
presenting available rapid response data to a user.

32. A method according to claim 31 further comprising: merging responses to said one or more requests for third-party data into data presented to a user.

33. A method according to claim 31 wherein said presenting includes indications that requested third-party data is yet to be received.

34. A method according to claim 31 wherein said third-party data is maintained by at least one third-party data manager using one or more data formats different from a format used for said initial storage.

35. A method according to claim 34 wherein a portion of said third-party data is resident on at least one third-party computer system including a resident agent for formatting responses to said requests for third-party data.

36. The method according to claim 31 further comprising: during an rapid event initiating a contact to an authorized recipient.

37. The method according to claim 31 further comprising: maintaining an event log for an rapid response event.

38. The method according to claim 37 further comprising: allowing a third-party to write data to said event log.

39. The method according to claim 37 wherein said event log may include a schedule of follow-up tasks some of which may be supplied by said third-party data sources.

40. The method according to claim 37 wherein said event log is accessible to an authorized user over a public access data network during retrieval of the rapid response data.

41. A method of providing rapid response information using an open protocol data structure comprising:
initiating a request for rapid response data at least one of: a telecommunications carrier central office callerID switch or telecommunications call center;
attempting to respond to said request at an initial data source;
at said initial data source, forwarding said request to one or more upstream authoritative servers;
retrieving a data record and initiating requests for external data; and
at an upstream authoritative server, formatting and merging external data for transfer to said local data source.

42. A method according to claim 41 wherein said external requests are transmitted using a standard transfer protocol.

43. A method according to claim 42 wherein said requests are transmitted using HTTP.

44. A method according to claim 41 wherein responses to said requests for external data are encoded in a self-describing data format.

45. A method according to claim 44 wherein responses to said requests for external data are encoded in an XML compatible data format.

46. A method according to claim 44 wherein data fields in a record can reference other data sources.

47-48. (canceled)

49. A rapid response data storage hub system comprising:
an interface for communicating with one or more telecommunications carrier central office callerID switches or telecommunications call center systems;
an interface for communicating with one or more third-party data providers;
an interface for communicating with an on-scene rapid response provider;
an interface for communicating with one or more subscriber specified endpoints;
a data resolution and merge process able to:
read stored data records with embedded external data references;
initiate requests for external data; and
merge external data received from at least one of the interfaces included in the rapid response data storage hub system into a record for deliver to a telecommunications carrier central office callerID switches or telecommunications call center systems.

50. A system according to claim 49 further comprising: an interface for communicating with one or more local redundant data stores; and logic routines allowing for the bulk updating of data on said one or more local redundant data stores.

51. A system according to claim 49 further comprising: rapid response log storage able to store ongoing rapid response data and activities for access by authorized users.

52. A system according to claim 51 further comprising: an interface allowing automatic access to a rapid response log by an authorized user.
